(19) United States
(12) Patent Application Publication
(10) Pub. No.: US 2026/0003168 A1
(43) Pub. Date: Jan. 1, 2026

(54) ANAMORPHIC LENS MODULE

(71) Applicant: GoPro, Inc., San Mateo, CA (US)

(72) Inventors: Ian Copeland Griggs, San Francisco, CA (US); Jonathan Michael Stern, San Mateo, CA (US); Ying-Moh Liu, Irvine, CA (US)

(21) Appl. No.: 18/819,194

(22) Filed: Aug. 29, 2024

Related U.S. Application Data
(63) Continuation-in-part of application No. 29/949,371, filed on Jun. 26, 2024.
(63) Continuation-in-part of application No. 29/949,373, filed on Jun. 26, 2024.

(51) Int. Cl. G02B 13/08; G02B 1/04; G02B 27/00; G03B 17/08; G03B 17/12

(52) U.S. Cl. CPC G02B 13/08; G02B 1/041; G02B 27/0006; G03B 17/08; G03B 17/12; G03B 2217/002

(57) ABSTRACT

An image capture device that includes a lens barrel disposed in a body of the image capture device and an anamorphic lens module configured to be coupled to the image capture device. The anamorphic lens module includes a housing that defines a cavity therein, one or more lenses disposed in the cavity of the housing and aligned along an optical axis of the anamorphic lens module, and a cover glass disposed in the housing and positioned outward from the one or more lens along the optical axis. The optical axis of the anamorphic lens module is configured to be aligned with an optical axis of the lens barrel. An interior surface of the cover glass faces the one or more lenses and an exterior surface of the cover glass forms at least a portion of an exterior surface of the anamorphic lens module.

### CROSS-REFERENCE TO RELATED APPLICATIONS

This application is a continuation-in-part of U.S. Design Application Ser. No. 29/949,373, filed on Jun. 26, 2024, and U.S. Design Application Ser. No. 29/949,371, filed on Jun. 26, 2024, the contents of which are incorporated herein by reference in their entirety.

### TECHNICAL FIELD

This disclosure relates to an optical system, and more specifically, to an image capture device that includes an anamorphic lens module.

### BACKGROUND

Typical cameras may include one or more lenses so that images may be taken through the lenses (e.g., using one or more image sensors). The lenses may be connected within an image capture device so that alignment of the lenses is maintained. The lenses may be connected to a frame or to each other so that proper alignment is achieved and maintained. The lenses may also be fixed in place to prevent misalignment when the image capture device is dropped or impacted, thereby constraining adjustability of the lenses. It may be difficult to capture clear images or videos due to the lack of adjustability, thereby preventing a user from focusing one or more of the lenses.

### SUMMARY

In one implementation, an image capture device is disclosed. The image capture device includes a lens barrel disposed in a body of the image capture device and an anamorphic lens module configured to be coupled to the image capture device. The anamorphic lens module includes a housing that defines a cavity therein, one or more lenses disposed in the cavity of the housing and aligned along an optical axis of the anamorphic lens module, and a cover glass disposed in the housing and positioned outward from the one or more lens along the optical axis. An interior surface of the cover glass faces the one or more lenses and an exterior surface of the cover glass forms at least a portion of an exterior surface of the anamorphic lens module. The one or more lenses are plastic and the cover glass is a chemically strengthened glass.

In certain implementations, the interior surface and the exterior surface of the cover glass are contoured to increase a field of view of the image capture device.

In certain implementations, a length of the cover glass measured perpendicular to the optical axis of the anamorphic lens module may be greater than a width of the cover glass measured perpendicular to the optical axis of the anamorphic lens module and transverse to the length of the cover glass.

In certain implementations, the anamorphic lens module may be removably coupled to the image capture device to form a waterproof seal therebetween.

In certain implementations, the anamorphic lens module may further include a trim ring coupled to the housing and that extends inward towards the optical axis of the anamorphic lens module to cover a peripheral edge of the cover glass. The trim ring may include a base coupled to the housing and a flange integrally formed with the base and extending inward from the base towards the optical axis to cover the peripheral edge of the cover glass.

In certain implementations, the cover glass may be bonded to the housing to form a waterproof seal therebetween.

In certain implementations, the cover glass may include a continuous profile extending along a length of the cover glass. The cover glass may also include a contour profile along a width of the cover glass.

In another implementation, an anamorphic lens module for an image capture device is disclosed. The anamorphic lens module includes an outer casing, a housing at least partially disposed in the outer casing and that defines a cavity therein, one or more lenses disposed in the cavity of the housing and aligned along an optical axis of the anamorphic lens module, a cover glass coupled to the housing and aligned with the one or more lenses along the optical axis of the anamorphic lens module, and a mounting plate configured to removably couple the anamorphic lens module to the image capture device. The cover glass is positioned outward from the one or more lenses and is radially asymmetrical. The mounting plate is also configured to axially align the optical axis of the anamorphic lens module with an optical axis of a lens barrel of the image capture device.

In certain implementations, the mounting plate may include one or more lips configured to engage a bayonet of the lens barrel based upon rotation of the anamorphic lens module with respect to the bayonet about the optical axis of the lens barrel. The mounting plate may also include one or more hard stops configured to prevent further rotation of the anamorphic lens module about the optical axis of the lens barrel when the anamorphic lens module is rotationally aligned with the lens barrel. The mounting plate may further include a gasket configured to be positioned between the mounting plate and the bayonet to form a waterproof seal between the mounting plate and the lens barrel. The gasket may be disposed along at least a portion of an exterior surface of the mounting plate. Additionally, the one or more lips may each include a rotation bump that is configured to create an angled contact between the mounting plate and the bayonet to compress the gasket between the mounting plate and the bayonet.

In certain implementations, the housing may define a cover glass channel that extends adjacent to the cover glass. The cover glass channel may be configured to receive an adhesive to couple the cover glass to the housing. The anamorphic lens module may further include a trim ring coupled to the housing that covers both a peripheral edge of the cover and the cover glass channel from view from a viewpoint external to the anamorphic lens module. The trim ring may include a base that couples the trim ring to the housing and may be at least partially received by the cover glass channel. The housing may also define one or more lens channels for each of the one or more lenses. The one or more lens channels may be configured to receive an adhesive to couple a respective one of the one or more lenses to the housing.

In certain implementations, the one or more lenses may include a first lens positioned internal to the cover glass along the optical axis of the anamorphic lens module such that an interior surface of the cover glass may be positioned adjacent to an exterior surface of the first lens. A contour of the interior surface of the cover glass may be complementary in shaped to a contour of the exterior surface of the first lens. The first lens may be radially asymmetrical.

In another implementation, an image capture device is disclosed. The image capture device includes a lens barrel disposed in a body of the image capture device, one or more lenses disposed in the lens barrel, and a lens cover assembly configured to be coupled to the lens barrel. The lens cover assembly includes a housing, a frame coupled to the housing and configured to couple the lens cover assembly to the lens barrel, and a cover glass disposed in the housing and configured to be positioned external to the lens barrel. The cover glass includes an interior surface that faces the lens barrel and an opposing exterior surface. Both the interior surface and the opposing exterior surface are contoured.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIGS. 1A-1B are isometric views of an example of an image capture apparatus.

FIGS. 2A-2B are isometric views of another example of an image capture apparatus.

FIG. 3 is a top view of another example of an image capture apparatus.

FIGS. 4A-4B are isometric views of another example of an image capture apparatus.

FIG. 5 is a block diagram of electronic components of an image capture apparatus.

FIG. 6 is an isometric view of an example of an anamorphic lens module.

FIG. 7 is an isometric exploded view of an image capture device.

FIG. 8A is the cross-sectional view 8A-8A of the anamorphic lens module shown in FIG. 6.

FIG. 8B is the cross-sectional view 8B-8B of the anamorphic lens module shown in FIG. 6.

FIG. 9A is a close-up isometric view of the anamorphic lens module shown in FIG. 8A.

FIG. 9B is a close-up isometric view of the anamorphic lens module shown in FIG. 8B.

FIG. 10 is an isometric view of a mounting plate of the anamorphic lens module shown in FIG. 6.

FIG. 11 is an isometric view of a housing of the anamorphic lens module shown in FIG. 6.

FIGS. 12A-12B are isometric views of an example of a lens cover module.

FIG. 13A is cross-sectional view 13A-13A of the lens cover module shown in FIGS. 12A-12B.

FIG. 13B is another example of a cross-sectional view of the lens cover module shown in FIGS. 12A-12B.

### DETAILED DESCRIPTION

An anamorphic lens module may be configured to connect to an image capture device. The image capture device may include one or more lenses that are fixed within the image capture device (e.g., internal lenses integrated with, or coupled to, a lens barrel of the image capture device) and one or more lenses that are removable, interchangeable, or both (e.g., lenses of the anamorphic lens module). The anamorphic lens module may be located in front of, or external to, the lenses that are fixed within the image capture device. The anamorphic lens module may be removed from the image capture device for replacement or modification, and then recoupled to the image capture device. The anamorphic lens module may be completely or partially sealed with respect to the image capture device.

In order for images or videos to be captured, the anamorphic lens module and the internal lenses of the image capture device are aligned along an optical axis of the image capture device. The anamorphic lens module and the internal lenses of the image capture device may be subject to build tolerances that, if not followed, could cause misalignment and negatively impact capture of the images or videos. Additionally, if the image capture device is accidentally dropped or impacted, the anamorphic lens module may be damaged or may become misaligned with the internal lenses, thereby negatively impacting the capture of the images or the videos. Furthermore, the internal lenses of the image capture device may constrain a field of view of the image capture device, thereby constraining the extent to which the image capture device may capture the images or videos in a surrounding area.

An anamorphic lens module is described herein that achieves and/or maintains proper alignment between the internal lenses of the image capture device and the lenses of the anamorphic lens module so that the images or videos captured are clear and complete without distortion. Furthermore, the anamorphic lens module may increase or otherwise improve a field of view of the image capture device such that a greater portion of the surrounding area may be captured by the image capture device in the images or videos. Moreover, the anamorphic lens module may provide the greater or improved field of view while still maintaining proper alignment with the internal lenses of the image capture device. Additionally, the anamorphic lens module may movably couple to the image capture device to facilitate interchangeability and/or replacement of the anamorphic lens module.

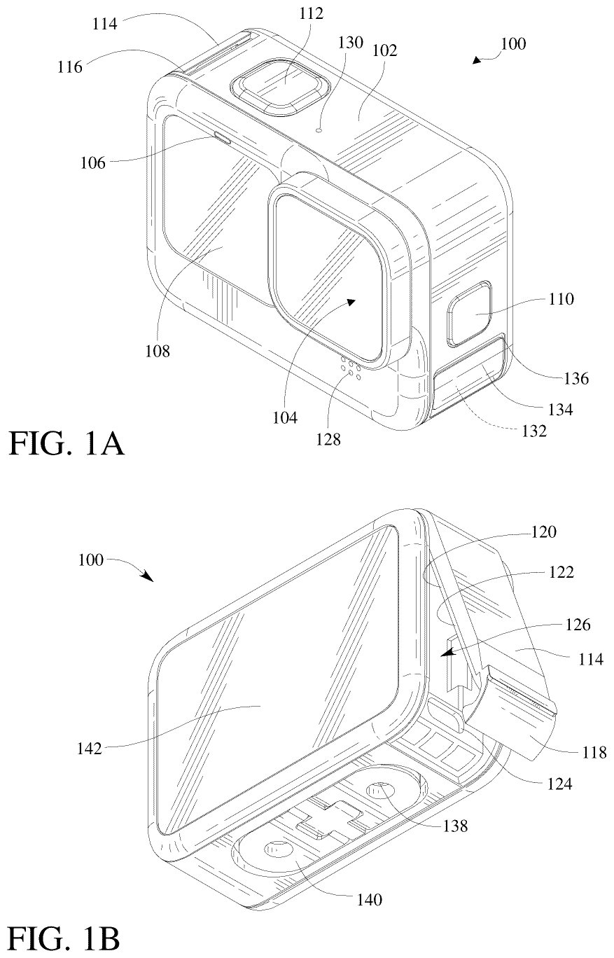

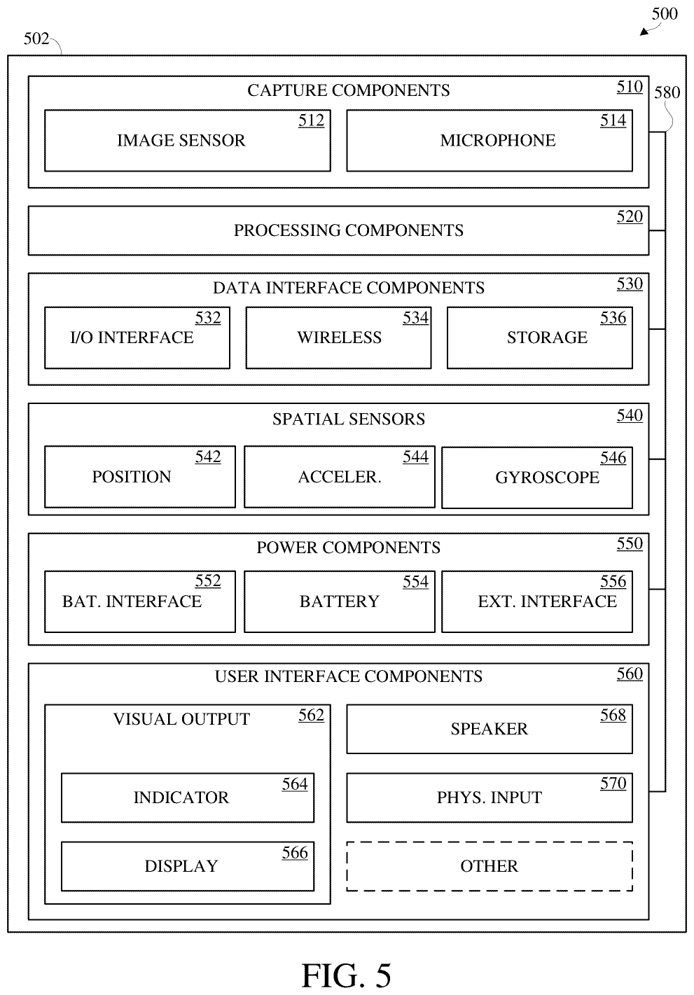

FIGS. 1A-1B are isometric views of an example of an image capture apparatus 100. The image capture apparatus 100 includes a body 102, an image capture device 104, an indicator 106, a display 108, a mode button 110, a shutter button 112, a door 114, a hinge mechanism 116, a latch mechanism 118, a seal 120, a battery interface 122, a data interface 124, a battery receptacle 126, microphones 128, 130, 132, a speaker 138, an interconnect mechanism 140, and a display 142. Although not expressly shown in FIGS. 1A-1B, the image capture apparatus 100 includes internal electronics, such as imaging electronics, power electronics, and the like, internal to the body 102 for capturing images and performing other functions of the image capture apparatus 100. An example showing internal electronics is shown in FIG. 5. The arrangement of the components of the image capture apparatus 100 shown in FIGS. 1A-1B is an example, other arrangements of elements may be used, except as is described herein or as is otherwise clear from context.

The body 102 of the image capture apparatus 100 may be made of a rigid material such as plastic, aluminum, steel, or fiberglass. Other materials may be used. The image capture device 104 is structured on a front surface of, and within, the body 102. The image capture device 104 includes a lens. The lens of the image capture device 104 receives light incident upon the lens of the image capture device 104 and directs the received light onto an image sensor of the image capture device 104 internal to the body 102. The image capture apparatus 100 may capture one or more images, such as a sequence of images, such as video. The image capture apparatus 100 may store the captured images and video for subsequent display, playback, or transfer to an external device. Although one image capture device 104 is shown in FIG. 1A, the image capture apparatus 100 may include multiple image capture devices, which may be structured on respective surfaces of the body 102.

As shown in FIG. 1A, the image capture apparatus 100 includes the indicator 106 structured on the front surface of the body 102. The indicator 106 may output, or emit, visible light, such as to indicate a status of the image capture apparatus 100. For example, the indicator 106 may be a light-emitting diode (LED). Although one indicator 106 is shown in FIG. 1A, the image capture apparatus 100 may include multiple indictors structured on respective surfaces of the body 102.

As shown in FIG. 1A, the image capture apparatus 100 includes the display 108 structured on the front surface of the body 102. The display 108 outputs, such as presents or displays, such as by emitting visible light, information, such as to show image information such as image previews, live video capture, or status information such as battery life, camera mode, elapsed time, and the like. In some implementations, the display 108 may be an interactive display, which may receive, detect, or capture input, such as user input representing user interaction with the image capture apparatus 100. In some implementations, the display 108 may be omitted or combined with another component of the image capture apparatus 100.

As shown in FIG. 1A, the image capture apparatus 100 includes the mode button 110 structured on a side surface of the body 102. Although described as a button, the mode button 110 may be another type of input device, such as a switch, a toggle, a slider, or a dial. Although one mode button 110 is shown in FIG. 1A, the image capture apparatus 100 may include multiple mode, or configuration, buttons structured on respective surfaces of the body 102. In some implementations, the mode button 110 may be omitted or combined with another component of the image capture apparatus 100. For example, the display 108 may be an interactive, such as touchscreen, display, and the mode button 110 may be physically omitted and functionally combined with the display 108.

As shown in FIG. 1A, the image capture apparatus 100 includes the shutter button 112 structured on a top surface of the body 102. The shutter button 112 may be another type of input device, such as a switch, a toggle, a slider, or a dial. The image capture apparatus 100 may include multiple shutter buttons structured on respective surfaces of the body 102. In some implementations, the shutter button 112 may be omitted or combined with another component of the image capture apparatus 100.

The mode button 110, the shutter button 112, or both, obtain input data, such as user input data in accordance with user interaction with the image capture apparatus 100. For example, the mode button 110, the shutter button 112, or both, may be used to turn the image capture apparatus 100 on and off, scroll through modes and settings, and select modes and change settings.

As shown in FIG. 1B, the image capture apparatus 100 includes the door 114 coupled to the body 102, such as using the hinge mechanism 116 (FIG. 1A). The door 114 may be secured to the body 102 using the latch mechanism 118 that releasably engages the body 102 at a position generally opposite the hinge mechanism 116. The door 114 includes the seal 120 and the battery interface 122. Although one door 114 is shown in FIG. 1A, the image capture apparatus 100 may include multiple doors respectively forming respective surfaces of the body 102, or portions thereof. The door 114 may be removable from the body 102 by releasing the latch mechanism 118 from the body 102 and decoupling the hinge mechanism 116 from the body 102.

In FIG. 1B, the door 114 is shown in a partially open position such that the data interface 124 is accessible for communicating with external devices and the battery receptacle 126 is accessible for placement or replacement of a battery. In FIG. 1A, the door 114 is shown in a closed position. In implementations in which the door 114 is in the closed position, the seal 120 engages a flange (not shown) to provide an environmental seal and the battery interface 122 engages the battery (not shown) to secure the battery in the battery receptacle 126.

As shown in FIG. 1B, the image capture apparatus 100 includes the battery receptacle 126 structured to form a portion of an interior surface of the body 102. The battery receptacle 126 includes operative connections for power transfer between the battery and the image capture apparatus 100. In some implementations, the battery receptacle 126 may be omitted. The image capture apparatus 100 may include multiple battery receptacles.

As shown in FIG. 1A, the image capture apparatus 100 includes a first microphone 128 structured on a front surface of the body 102, a second microphone 130 structured on a top surface of the body 102, and a third microphone 132 structured on a side surface of the body 102. The third microphone 132, which may be referred to as a drain microphone and is indicated as hidden in dotted line, is located behind a drain cover 134, surrounded by a drain channel 136, and can drain liquid from audio components of the image capture apparatus 100. The image capture apparatus 100 may include other microphones on other surfaces of the body 102. The microphones 128, 130, 132 receive and record audio, such as in conjunction with capturing video or separate from capturing video. In some implementations, one or more of the microphones 128, 130, 132 may be omitted or combined with other components of the image capture apparatus 100.

As shown in FIG. 1B, the image capture apparatus 100 includes the speaker 138 structured on a bottom surface of the body 102. The speaker 138 outputs or presents audio, such as by playing back recorded audio or emitting sounds associated with notifications. The image capture apparatus 100 may include multiple speakers structured on respective surfaces of the body 102.

As shown in FIG. 1B, the image capture apparatus 100 includes the interconnect mechanism 140 structured on a bottom surface of the body 102. The interconnect mechanism 140 removably connects the image capture apparatus 100 to an external structure, such as a handle grip, another mount, or a securing device. The interconnect mechanism 140 includes folding protrusions configured to move between a nested or collapsed position as shown in FIG. 1B and an extended or open position. The folding protrusions of the interconnect mechanism 140 in the extended or open position may be coupled to reciprocal protrusions of other devices such as handle grips, mounts, clips, or like devices. The image capture apparatus 100 may include multiple interconnect mechanisms structured on, or forming a portion of, respective surfaces of the body 102. In some implementations, the interconnect mechanism 140 may be omitted.

As shown in FIG. 113, the image capture apparatus 100 includes the display 142 structured on, and forming a portion of, a rear surface of the body 102. The display 142 outputs, such as presents or displays, such as by emitting visible light, data, such as to show image information such as image previews, live video capture, or status information such as battery life, camera mode, elapsed time, and the like. In some implementations, the display 142 may be an interactive display, which may receive, detect, or capture input, such as user input representing user interaction with the image capture apparatus 100. The image capture apparatus 100 may include multiple displays structured on respective surfaces of the body 102, such as the displays 108, 142 shown in FIGS. 1A-1B. In some implementations, the display 142 may be omitted or combined with another component of the image capture apparatus 100.

The image capture apparatus 100 may include features or components other than those described herein, such as other buttons or interface features. In some implementations, interchangeable lenses, cold shoes, and hot shoes, or a combination thereof, may be coupled to or combined with the image capture apparatus 100. For example, the image capture apparatus 100 may communicate with an external device, such as an external user interface device, via a wired or wireless computing communication link, such as via the data interface 124. The computing communication link may be a direct computing communication link or an indirect computing communication link, such as a link including another device or a network, such as the Internet. The image capture apparatus 100 may transmit images to the external device via the computing communication link.

The external device may store, process, display, or combination thereof, the images. The external user interface device may be a computing device, such as a smartphone, a tablet computer, a smart watch, a portable computer, personal computing device, or another device or combination of devices configured to receive user input, communicate information with the image capture apparatus 100 via the computing communication link, or receive user input and communicate information with the image capture apparatus 100 via the computing communication link. The external user interface device may implement or execute one or more applications to manage or control the image capture apparatus 100. For example, the external user interface device may include an application for controlling camera configuration, video acquisition, video display, or any other configurable or controllable aspect of the image capture apparatus 100. In some implementations, the external user interface device may generate and share, such as via a cloud-based or social media service, one or more images or video clips. In some implementations, the external user interface device may display unprocessed or minimally processed images or video captured by the image capture apparatus 100 contemporaneously with capturing the images or video by the image capture apparatus 100, such as for shot framing or live preview.

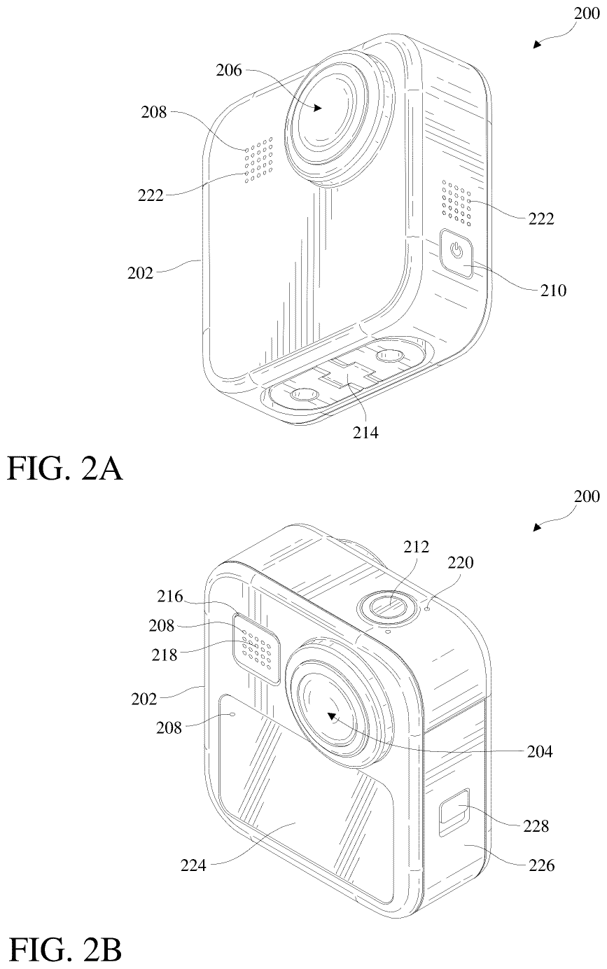

FIGS. 2A-2B illustrate another example of an image capture apparatus 200. The image capture apparatus 200 is similar to the image capture apparatus 100 shown in FIGS. 1A-1B. The image capture apparatus 200 includes a body 202, a first image capture device 204, a second image capture device 206, indicators 208, a mode button 210, a shutter button 212, an interconnect mechanism 214, a drainage channel 216, audio components 218, 220, 222, a display 224, and a door 226 including a release mechanism 228. The arrangement of the components of the image capture apparatus 200 shown in FIGS. 2A-2B is an example, other arrangements of elements may be used.

The body 202 of the image capture apparatus 200 may be similar to the body 102 shown in FIGS. 1A-1B. The first image capture device 204 is structured on a front surface of the body 202. The first image capture device 204 includes a first lens. The first image capture device 204 may be similar to the image capture device 104 shown in FIG. 1A. As shown in FIG. 2A, the image capture apparatus 200 includes the second image capture device 206 structured on a rear surface of the body 202. The second image capture device 206 includes a second lens. The second image capture device 206 may be similar to the image capture device 104 shown in FIG. 1A. The image capture devices 204, 206 are disposed on opposing surfaces of the body 202, for example, in a back-to-back configuration, Janus configuration, or offset Janus configuration. The image capture apparatus 200 may include other image capture devices structured on respective surfaces of the body 202.

As shown in FIG. 2B, the image capture apparatus 200 includes the indicators 208 associated with the audio component 218 and the display 224 on the front surface of the body 202. The indicators 208 may be similar to the indicator 106 shown in FIG. 1A. For example, one of the indicators 208 may indicate a status of the first image capture device 204 and another one of the indicators 208 may indicate a status of the second image capture device 206. Although two indicators 208 are shown in FIGS. 2A-2B, the image capture apparatus 200 may include other indictors structured on respective surfaces of the body 202.

As shown in FIGS. 2A-2B, the image capture apparatus 200 includes input mechanisms including the mode button 210, structured on a side surface of the body 202, and the shutter button 212, structured on a top surface of the body 202. The mode button 210 may be similar to the mode button 110 shown in FIG. 1B. The shutter button 212 may be similar to the shutter button 112 shown in FIG. 1A.

The image capture apparatus 200 includes internal electronics (not expressly shown), such as imaging electronics, power electronics, and the like, internal to the body 202 for capturing images and performing other functions of the image capture apparatus 200. An example showing internal electronics is shown in FIG. 5.

As shown in FIGS. 2A-2B, the image capture apparatus 200 includes the interconnect mechanism 214 structured on a bottom surface of the body 202. The interconnect mechanism 214 may be similar to the interconnect mechanism 140 shown in FIG. 1B.

As shown in FIG. 2B, the image capture apparatus 200 includes the drainage channel 216 for draining liquid from audio components of the image capture apparatus 200.

As shown in FIGS. 2A-2B, the image capture apparatus 200 includes the audio components 218, 220, 222, respectively structured on respective surfaces of the body 202. The audio components 218, 220, 222 may be similar to the microphones 128, 130, 132 and the speaker 138 shown in FIGS. 1A-1B. One or more of the audio components 218, 220, 222 may be, or may include, audio sensors, such as microphones, to receive and record audio signals, such as voice commands or other audio, in conjunction with capturing images or video. One or more of the audio components 218, 220, 222 may be, or may include, an audio presentation component that may present, or play, audio, such as to provide notifications or alerts.

As shown in FIGS. 2A-2B, a first audio component 218 is located on a front surface of the body 202, a second audio component 220 is located on a top surface of the body 202, and a third audio component 222 is located on a back surface of the body 202. Other numbers and configurations for the audio components 218, 220, 222 may be used. For example, the audio component 218 may be a drain microphone surrounded by the drainage channel 216 and adjacent to one of the indicators 208 as shown in FIG. 2B.

As shown in FIG. 2B, the image capture apparatus 200 includes the display 224 structured on a front surface of the body 202. The display 224 may be similar to the displays 108, 142 shown in FIGS. 1A-1B. The display 224 may include an I/O interface. The display 224 may include one or more of the indicators 208. The display 224 may receive touch inputs. The display 224 may display image information during video capture. The display 224 may provide status information to a user, such as status information indicating battery power level, memory card capacity, time elapsed for a recorded video, etc. The image capture apparatus 200 may include multiple displays structured on respective surfaces of the body 202. In some implementations, the display 224 may be omitted or combined with another component of the image capture apparatus 200.

As shown in FIG. 2B, the image capture apparatus 200 includes the door 226 structured on, or forming a portion of, the side surface of the body 202. The door 226 may be similar to the door 114 shown in FIG. 1A. For example, the door 226 shown in FIG. 2A includes a release mechanism 228. The release mechanism 228 may include a latch, a button, or other mechanism configured to receive a user input that allows the door 226 to change position. The release mechanism 228 may be used to open the door 226 for a user to access a battery, a battery receptacle, an I/O interface, a memory card interface, etc.

In some embodiments, the image capture apparatus 200 may include features or components other than those described herein, some features or components described herein may be omitted, or some features or components described herein may be combined. For example, the image capture apparatus 200 may include additional interfaces or different interface features, interchangeable lenses, cold shoes, or hot shoes.

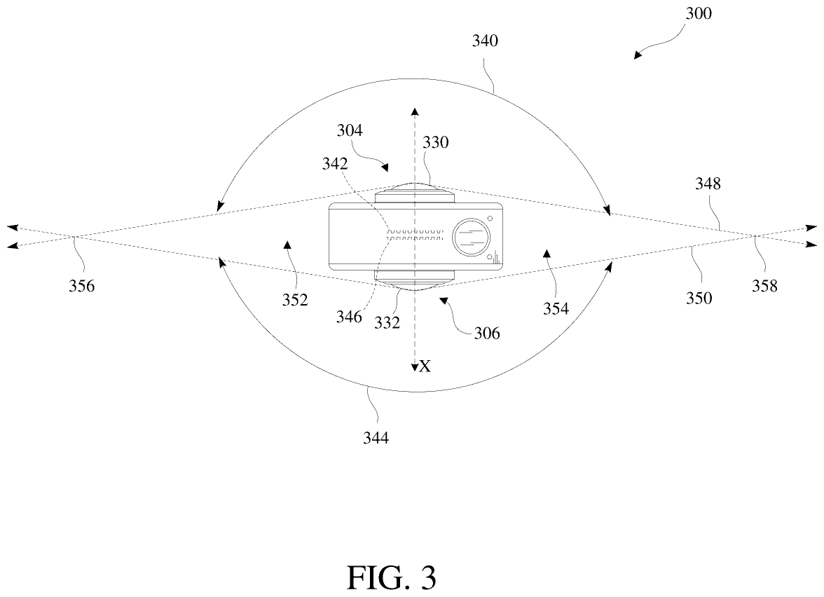

FIG. 3 is a top view of an image capture apparatus 300. The image capture apparatus 300 is similar to the image capture apparatus 200 of FIGS. 2A-2B and is configured to capture spherical images.

As shown in FIG. 3, a first image capture device 304 includes a first lens 330 and a second image capture device 306 includes a second lens 332. For example, the first image capture device 304 may capture a first image, such as a first hemispheric, or hyper-hemispherical, image, the second image capture device 306 may capture a second image, such as a second hemispheric, or hyper-hemispherical, image, and the image capture apparatus 300 may generate a spherical image incorporating or combining the first image and the second image, which may be captured concurrently, or substantially concurrently.

The first image capture device 304 defines a first field-of-view 340 wherein the first lens 330 of the first image capture device 304 receives light. The first lens 330 directs the received light corresponding to the first field-of-view 340 onto a first image sensor 342 of the first image capture device 304. For example, the first image capture device 304 may include a first lens barrel (not expressly shown), extending from the first lens 330 to the first image sensor 342.

The second image capture device 306 defines a second field-of-view 344 wherein the second lens 332 receives light. The second lens 332 directs the received light corresponding to the second field-of-view 344 onto a second image sensor 346 of the second image capture device 306. For example, the second image capture device 306 may include a second lens barrel (not expressly shown), extending from the second lens 332 to the second image sensor 346.

A boundary 348 of the first field-of-view 340 is shown using broken directional lines. A boundary 350 of the second field-of-view 344 is shown using broken directional lines. As shown, the image capture devices 304, 306 are arranged in a back-to-back (Janus) configuration such that the lenses 330, 332 face in opposite directions, and such that the image capture apparatus 300 may capture spherical images. The first image sensor 342 detects a first hyper-hemispherical image plane from light entering the first lens 330. The second image sensor 346 detects a second hyper-hemispherical image plane from light entering the second lens 332.

As shown in FIG. 3, the fields-of-view 340, 344 partially overlap such that the combination of the fields-of-view 340, 344 forms a spherical field-of-view, except that one or more uncaptured areas 352, 354 may be outside of the fields-of-view 340, 344 of the lenses 330, 332. Light emanating from or passing through the uncaptured areas 352, 354, which may be proximal to the image capture apparatus 300, may be obscured from the lenses 330, 332 and the corresponding image sensors 342, 346, such that content corresponding to the uncaptured areas 352, 354 may be omitted from images captured by the image capture apparatus 300. In some implementations, the image capture devices 304, 306, or the lenses 330, 332 thereof, may be configured to minimize the uncaptured areas 352, 354.

Examples of points of transition, or overlap points, from the uncaptured areas 352, 354 to the overlapping portions of the fields-of-view 340, 344 are shown at 356, 358.

Images contemporaneously detected by the respective image sensors 342, 346 may be combined to form a combined image, such as a spherical image. Generating a combined image may include correlating the overlapping regions detected by the respective image sensors 342, 346, aligning the captured fields-of-view 340, 344, and stitching the images together to form a cohesive combined image. Stitching the images together may include correlating the overlap points 356, 358 with respective locations in corresponding images detected by the image sensors 342, 346. Although a planar view of the fields-of-view 340, 344 is shown in FIG. 3, the fields-of-view 340, 344 are hyper-hemispherical.

A change in the alignment, such as position, tilt, or a combination thereof, of the image capture devices 304, 306, such as of the lenses 330, 332, the image sensors 342, 346, or both, may change the relative positions of the respective fields-of-view 340, 344, may change the locations of the overlap points 356, 358, such as with respect to images detected by the image sensors 342, 346, and may change the uncaptured areas 352, 354, which may include changing the uncaptured areas 352, 354 unequally.

Incomplete or inaccurate information indicating the alignment of the image capture devices 304, 306, such as the locations of the overlap points 356, 358, may decrease the accuracy, efficiency, or both of generating a combined image. In some implementations, the image capture apparatus 300 may maintain information indicating the location and orientation of the image capture devices 304, 306, such as of the lenses 330, 332, the image sensors 342, 346, or both, such that the fields-of-view 340, 344, the overlap points 356, 358, or both may be accurately determined, which may improve the accuracy, efficiency, or both of generating a combined image.

The lenses 330, 332 may be aligned along an axis X as shown, laterally offset from each other (not shown), off-center from a central axis of the image capture apparatus 300 (not shown), or laterally offset and off-center from the central axis (not shown). Whether through use of offset or through use of compact image capture devices 304, 306, a reduction in distance between the lenses 330, 332 along the axis X may improve the overlap in the fields-of-view 340, 344, such as by reducing the uncaptured areas 352, 354.

Images or frames captured by the image capture devices 304, 306 may be combined, merged, or stitched together to produce a combined image, such as a spherical or panoramic image, which may be an equirectangular planar image. In some implementations, generating a combined image may include use of techniques such as noise reduction, tone mapping, white balancing, or other image correction. In some implementations, pixels along a stitch boundary, which may correspond with the overlap points 356, 358, may be matched accurately to minimize boundary discontinuities.

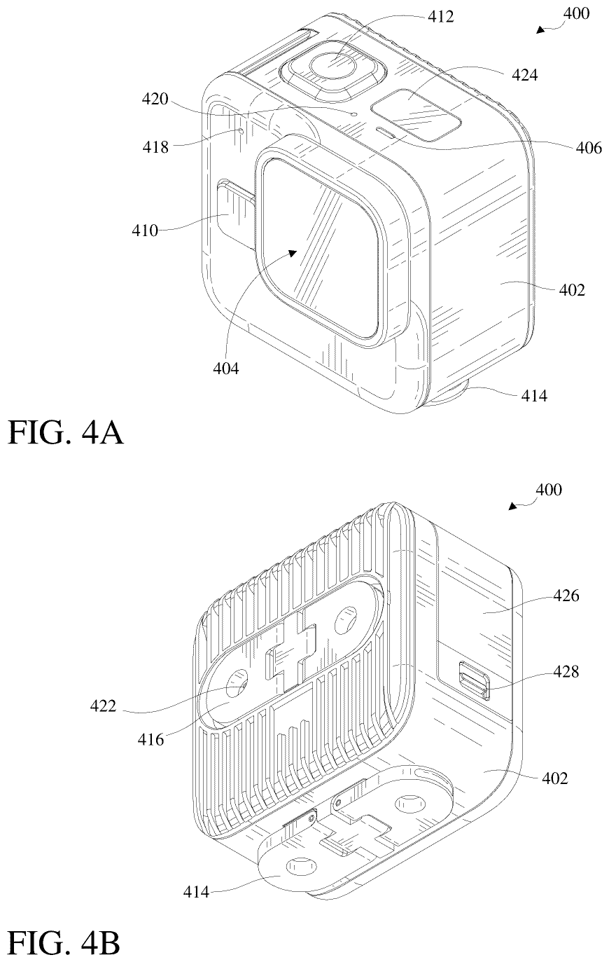

FIGS. 4A-4B illustrate another example of an image capture apparatus 400. The image capture apparatus 400 is similar to the image capture apparatus 100 shown in FIGS. 1A-1B and to the image capture apparatus 200 shown in FIGS. 2A-2B. The image capture apparatus 400 includes a body 402, an image capture device 404, an indicator 406, a mode button 410, a shutter button 412, interconnect mechanisms 414, 416, audio components 418, 420, 422, a display 424, and a door 426 including a release mechanism 428. The arrangement of the components of the image capture apparatus 400 shown in FIGS. 4A-4B is an example, other arrangements of elements may be used.

The body 402 of the image capture apparatus 400 may be similar to the body 102 shown in FIGS. 1A-1B. The image capture device 404 is structured on a front surface of the body 402. The image capture device 404 includes a lens and may be similar to the image capture device 104 shown in FIG. 1A.

As shown in FIG. 4A, the image capture apparatus 400 includes the indicator 406 on a top surface of the body 402. The indicator 406 may be similar to the indicator 106 shown in FIG. 1A. The indicator 406 may indicate a status of the image capture device 204. Although one indicator 406 is shown in FIGS. 4A, the image capture apparatus 400 may include other indictors structured on respective surfaces of the body 402.

As shown in FIGS. 4A, the image capture apparatus 400 includes input mechanisms including the mode button 410, structured on a front surface of the body 402, and the shutter button 412, structured on a top surface of the body 402. The mode button 410 may be similar to the mode button 110 shown in FIG. 1B. The shutter button 412 may be similar to the shutter button 112 shown in FIG. 1A.

The image capture apparatus 400 includes internal electronics (not expressly shown), such as imaging electronics, power electronics, and the like, internal to the body 402 for capturing images and performing other functions of the image capture apparatus 400. An example showing internal electronics is shown in FIG. 5.

As shown in FIGS. 4A-4B, the image capture apparatus 400 includes the interconnect mechanisms 414, 416, with a first interconnect mechanism 414 structured on a bottom surface of the body 402 and a second interconnect mechanism 416 disposed within a rear surface of the body 402. The interconnect mechanisms 414, 416 may be similar to the interconnect mechanism 140 shown in FIG. 1B and the interconnect mechanism 214 shown in FIG. 2A.

As shown in FIGS. 4A-4B, the image capture apparatus 400 includes the audio components 418, 420, 422 respectively structured on respective surfaces of the body 402. The audio components 418, 420, 422 may be similar to the microphones 128, 130, 132 and the speaker 138 shown in FIGS. 1A-1B. One or more of the audio components 418, 420, 422 may be, or may include, audio sensors, such as microphones, to receive and record audio signals, such as voice commands or other audio, in conjunction with capturing images or video. One or more of the audio components 418, 420, 422 may be, or may include, an audio presentation component that may present, or play, audio, such as to provide notifications or alerts.

As shown in FIGS. 4A-4B, a first audio component 418 is located on a front surface of the body 402, a second audio component 420 is located on a top surface of the body 402, and a third audio component 422 is located on a rear surface of the body 402. Other numbers and configurations for the audio components 418, 420, 422 may be used.

As shown in FIG. 4A, the image capture apparatus 400 includes the display 424 structured on a front surface of the body 402. The display 424 may be similar to the displays 108, 142 shown in FIGS. 1A-1B. The display 424 may include an I/O interface. The display 424 may receive touch inputs. The display 424 may display image information during video capture. The display 424 may provide status information to a user, such as status information indicating battery power level, memory card capacity, time elapsed for a recorded video, etc. The image capture apparatus 400 may include multiple displays structured on respective surfaces of the body 402. In some implementations, the display 424 may be omitted or combined with another component of the image capture apparatus 200.

As shown in FIG. 4B, the image capture apparatus 400 includes the door 426 structured on, or forming a portion of, the side surface of the body 402. The door 426 may be similar to the door 226 shown in FIG. 2B. The door 426 shown in FIG. 4B includes the release mechanism 428. The release mechanism 428 may include a latch, a button, or other mechanism configured to receive a user input that allows the door 426 to change position. The release mechanism 428 may be used to open the door 426 for a user to access a battery, a battery receptacle, an I/O interface, a memory card interface, etc.

In some embodiments, the image capture apparatus 400 may include features or components other than those described herein, some features or components described herein may be omitted, or some features or components described herein may be combined. For example, the image capture apparatus 400 may include additional interfaces or different interface features, interchangeable lenses, cold shoes, or hot shoes.

FIG. 5 is a block diagram of electronic components in an image capture apparatus 500. The image capture apparatus 500 may be a single-lens image capture device, a multi-lens image capture device, or variations thereof, including an image capture apparatus with multiple capabilities such as the use of interchangeable integrated sensor lens assemblies. Components, such as electronic components, of the image capture apparatus 100 shown in FIGS. 1A-1B, the image capture apparatus 200 shown in FIGS. 2A-2B, the image capture apparatus 300 shown in FIG. 3, or the image capture apparatus 400 shown in FIGS. 4A-4B, may be implemented as shown in FIG. 5.

The image capture apparatus 500 includes a body 502. The body 502 may be similar to the body 102 shown in FIGS. 1A-1B, the body 202 shown in FIGS. 2A-2B, or the body 402 shown in FIGS. 4A-4B. The body 502 includes electronic components such as capture components 510, processing components 520, data interface components 530, spatial sensors 540, power components 550, user interface components 560, and a bus 580.

The capture components 510 include an image sensor 512 for detecting images. Although one image sensor 512 is shown in FIG. 5, the capture components 510 may include multiple image sensors. The image sensor 512 may be similar to the image sensors 342, 346 shown in FIG. 3. The image sensor 512 may be, for example, a charge-coupled device (CCD) sensor, an active pixel sensor (APS), a complementary metal-oxide-semiconductor (CMOS) sensor, or an N-type metal-oxide-semiconductor (NMOS) sensor. The image sensor 512 detects light, such as within a defined spectrum, such as the visible light spectrum or the infrared spectrum, incident through a corresponding lens such as the first lens 330 with respect to the first image sensor 342 or the second lens 332 with respect to the second image sensor 346 as shown in FIG. 3. The image sensor 512 detects light as image data and conveys the image data as electrical signals (image signals or image data) to the other components of the image capture apparatus 500, such as to the processing components 520, such as via the bus 580.

The capture components 510 include a microphone 514 for capturing audio. Although one microphone 514 is shown in FIG. 5, the capture components 510 may include multiple microphones. The microphone 514 detects and captures, or records, sound, such as sound waves incident upon the microphone 514. The microphone 514 may detect, capture, or record sound in conjunction with image detection by the image sensor 512. The microphone 514 may detect sound to receive audible commands to control the image capture apparatus 500. The microphone 514 may be similar to the microphones 128, 130, 132 shown in FIGS. 1A-1B, the audio components 218, 220, 222 shown in FIGS. 2A-2B, or the audio components 418, 420, 422 shown in FIGS. 4A-4B.

The processing components 520 perform image signal processing, such as filtering, tone mapping, or stitching, to generate, or obtain, processed images, or processed image data, based on image data obtained from the image sensor 512. The processing components 520 may include one or more processors having single or multiple processing cores. In some implementations, the processing components 520 may include, or may be, an application specific integrated circuit (ASIC) or a digital signal processor (DSP). For example, the processing components 520 may include a custom image signal processor. The processing components 520 conveys data, such as processed image data, with other components of the image capture apparatus 500 via the bus 580. In some implementations, the processing components 520 may include an encoder, such as an image or video encoder that may encode, decode, or both, the image data, such as for compression coding, transcoding, or a combination thereof.

Although not shown expressly in FIG. 5, the processing components 520 may include memory, such as a random-access memory (RAM) device, which may be non-transitory computer-readable memory. The memory of the processing components 520 may include executable instructions and data that can be accessed by the processing components 520.

The data interface components 530 communicates with other, such as external, electronic devices, such as a remote control, a smartphone, a tablet computer, a laptop computer, a desktop computer, or an external computer storage device. For example, the data interface components 530 may receive commands to operate the image capture apparatus 500. In another example, the data interface components 530 may transmit image data to transfer the image data to other electronic devices. The data interface components 530 may be configured for wired communication, wireless communication, or both. As shown, the data interface components 530 include an I/O interface 532, a wireless data interface 534, and a storage interface 536. In some implementations, one or more of the I/O interface 532, the wireless data interface 534, or the storage interface 536 may be omitted or combined.

The I/O interface 532 may send, receive, or both, wired electronic communications signals. For example, the I/O interface 532 may be a universal serial bus (USB) interface, such as USB type-C interface, a high-definition multimedia interface (HDMI), a FireWire interface, a digital video interface link, a display port interface link, a Video Electronics Standards Associated (VESA) digital display interface link, an Ethernet link, or a Thunderbolt link. Although one I/O interface 532 is shown in FIG. 5, the data interface components 530 include multiple I/O interfaces. The I/O interface 532 may be similar to the data interface 124 shown in FIG. 1B.

The wireless data interface 534 may send, receive, or both, wireless electronic communications signals. The wireless data interface 534 may be a Bluetooth interface, a ZigBee interface, a Wi-Fi interface, an infrared link, a cellular link, a near field communications (NFC) link, or an Advanced Network Technology interoperability (ANT+) link. Although one wireless data interface 534 is shown in FIG. 5, the data interface components 530 include multiple wireless data interfaces. The wireless data interface 534 may be similar to the data interface 124 shown in FIG. 1B.

The storage interface 536 may include a memory card connector, such as a memory card receptacle, configured to receive and operatively couple to a removable storage device, such as a memory card, and to transfer, such as read, write, or both, data between the image capture apparatus 500 and the memory card, such as for storing images, recorded audio, or both captured by the image capture apparatus 500 on the memory card. Although one storage interface 536 is shown in FIG. 5, the data interface components 530 include multiple storage interfaces. The storage interface 536 may be similar to the data interface 124 shown in FIG. 1B.

The spatial, or spatiotemporal, sensors 540 detect the spatial position, movement, or both, of the image capture apparatus 500. As shown in FIG. 5, the spatial sensors 540 include a position sensor 542, an accelerometer 544, and a gyroscope 546. The position sensor 542, which may be a global positioning system (GPS) sensor, may determine a geospatial position of the image capture apparatus 500, which may include obtaining, such as by receiving, temporal data, such as via a GPS signal. The accelerometer 544, which may be a three-axis accelerometer, may measure linear motion, linear acceleration, or both of the image capture apparatus 500. The gyroscope 546, which may be a three-axis gyroscope, may measure rotational motion, such as a rate of rotation, of the image capture apparatus 500. In some implementations, the spatial sensors 540 may include other types of spatial sensors. In some implementations, one or more of the position sensor 542, the accelerometer 544, and the gyroscope 546 may be omitted or combined.

The power components 550 distribute electrical power to the components of the image capture apparatus 500 for operating the image capture apparatus 500. As shown in FIG. 5, the power components 550 include a battery interface 552, a battery 554, and an external power interface 556 (ext. interface). The battery interface 552 (bat. interface) operatively couples to the battery 554, such as via conductive contacts to transfer power from the battery 554 to the other electronic components of the image capture apparatus 500. The battery interface 552 may be similar to the battery receptacle 126 shown in FIG. 1B. The external power interface 556 obtains or receives power from an external source, such as a wall plug or external battery, and distributes the power to the components of the image capture apparatus 500, which may include distributing power to the battery 554 via the battery interface 552 to charge the battery 554. Although one battery interface 552, one battery 554, and one external power interface 556 are shown in FIG. 5, any number of battery interfaces, batteries, and external power interfaces may be used. In some implementations, one or more of the battery interface 552, the battery 554, and the external power interface 556 may be omitted or combined. For example, in some implementations, the external interface 556 and the I/O interface 532 may be combined.

The user interface components 560 receive input, such as user input, from a user of the image capture apparatus 500, output, such as display or present, information to a user, or both receive input and output information, such as in accordance with user interaction with the image capture apparatus 500.

As shown in FIG. 5, the user interface components 560 include visual output components 562 to visually communicate information, such as to present captured images. As shown, the visual output components 562 include an indicator 564 and a display 566. The indicator 564 may be similar to the indicator 106 shown in FIG. 1A, the indicators 208 shown in FIGS. 2A-2B, or the indicator 406 shown in FIG. 4A. The display 566 may be similar to the display 108 shown in FIG. 1A, the display 142 shown in FIG. 1B, the display 224 shown in FIG. 2B, or the display 424 shown in FIG. 4A. Although the visual output components 562 are shown in FIG. 5 as including one indicator 564, the visual output components 562 may include multiple indicators. Although the visual output components 562 are shown in FIG. 5 as including one display 566, the visual output components 562 may include multiple displays. In some implementations, one or more of the indicator 564 or the display 566 may be omitted or combined.

As shown in FIG. 5, the user interface components 560 include a speaker 568. The speaker 568 may be similar to the speaker 138 shown in FIG. 1B, the audio components 218, 220, 222 shown in FIGS. 2A-2B, or the audio components 418, 420, 422 shown in FIGS. 4A-4B. Although one speaker 568 is shown in FIG. 5, the user interface components 560 may include multiple speakers. In some implementations, the speaker 568 may be omitted or combined with another component of the image capture apparatus 500, such as the microphone 514.

As shown in FIG. 5, the user interface components 560 include a physical input interface 570. The physical input interface 570 may be similar to the mode buttons 110, 210, 410 shown in FIGS. 1A, 2A, and 4A or the shutter buttons 112, 212, 412 shown in FIGS. 1A, 2B, and 4A. Although one physical input interface 570 is shown in FIG. 5, the user interface components 560 may include multiple physical input interfaces. In some implementations, the physical input interface 570 may be omitted or combined with another component of the image capture apparatus 500. The physical input interface 570 may be, for example, a button, a toggle, a switch, a dial, or a slider.

As shown in FIG. 5, the user interface components 560 include a broken line border box labeled “other” to indicate that components of the image capture apparatus 500 other than the components expressly shown as included in the user interface components 560 may be user interface components. For example, the microphone 514 may receive, or capture, and process audio signals to obtain input data, such as user input data corresponding to voice commands. In another example, the image sensor 512 may detect, receive, or otherwise process image data to obtain input data, such as user input data corresponding to visible gesture commands. In another example, one or more of the spatial sensors 540, such as a combination of the accelerometer 544 and the gyroscope 546, may receive, or capture, and process motion data to obtain input data, such as user input data corresponding to motion gesture commands.

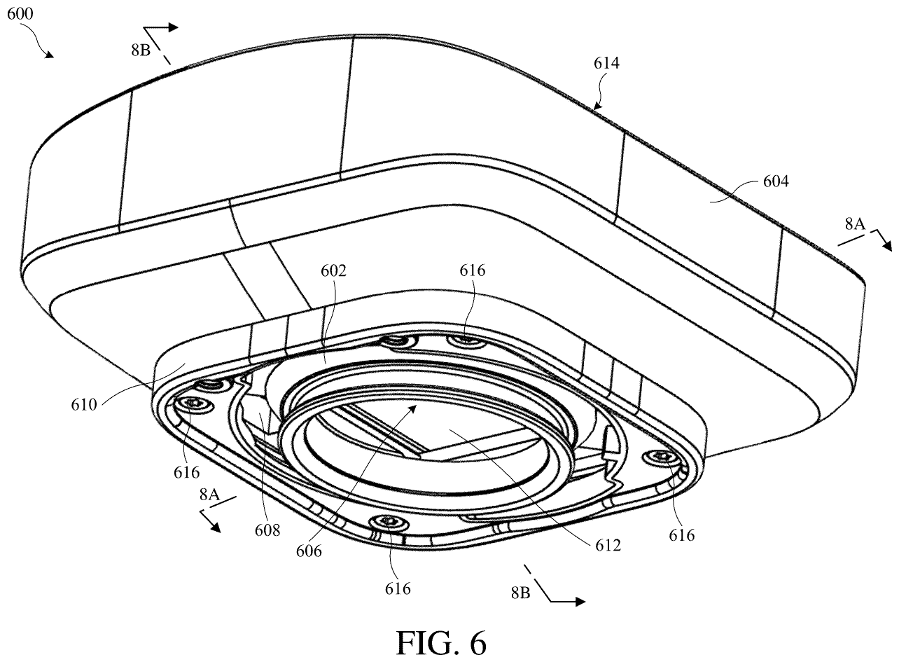

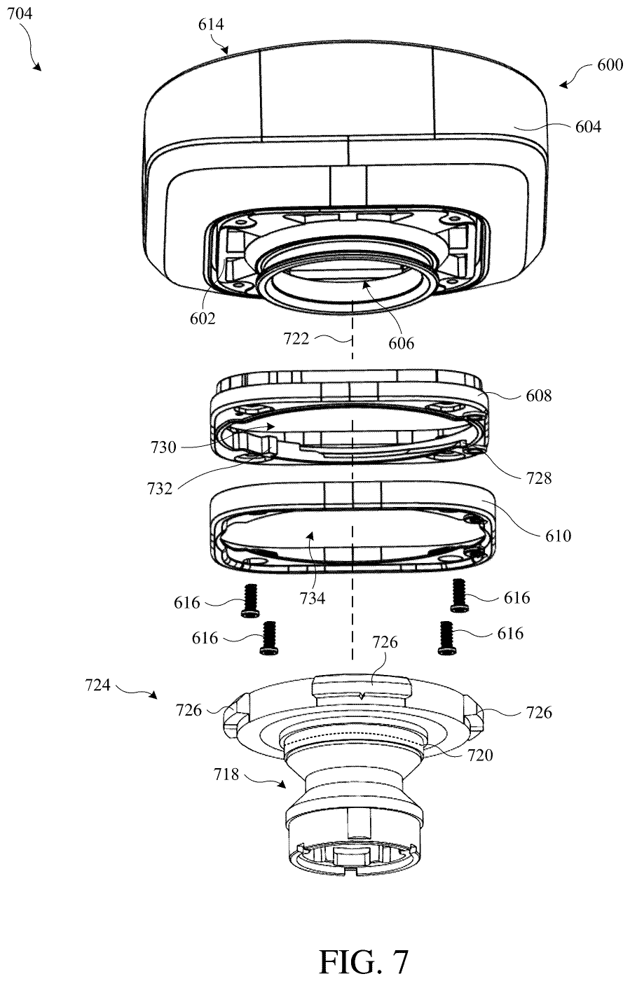

FIG. 6 is an isometric view of an anamorphic lens module 600. As discussed further below with respect to FIG. 7, the anamorphic lens module 600 may be configured to couple (e.g., removably couple) to an image capture device (e.g., a lens barrel of an image capture device). For example, the anamorphic lens module 600 may be configured to removably couple to the image capture devices 102, 204, 206, 304, 306, 404 described above.

The anamorphic lens module 600 may include a housing 602 disposed in an outer casing 604. The outer casing 604 may define a cavity the receives the housing 602 such that at least a portion of the housing 602 is located within the outer casing 604. Thus, the outer casing 604 may form at least a portion of an external surface of the anamorphic lens module 600 and may at least partially protect the housing 602 from moisture, debris, impact, or a combination thereof.

The housing 602 may define a cavity 606 therein. The housing 602 may define an overall size and/or shape of the anamorphic lens module 600. The housing 602 may also provide structural rigidity to the anamorphic lens module 600 to maintain its overall structural integrity and ensure proper alignment between the anamorphic lens module 600 and the image capture device. By way of example, the housing 602 may include, or be coupled to, a mounting plate 608. As discussed further below with respect to FIG. 7, the mounting plate 608 may releasably engage a lens barrel of the image capture device such that a gasket 610 may be compressed between the mounting plate 608 and the lens barrel. As a result, the mounting plate 608 and the gasket 610 may form a waterproof seal therebetween such that moisture and/or debris may be unable to penetrate the anamorphic lens module 600 or the image capture device through a connection point therebetween.

The housing 602 may contain (i.e., house) one or more lenses, such as a lens 612 of the anamorphic lens module 600. For example, the anamorphic lens module 600 may include a plurality of lenses (including the lens 612) that are disposed in and/or coupled to the housing 602. The one or more lenses within the housing 602 may be movable (e.g., to adjust a focus of the image capture device when capturing a picture or video) or may be fixed within the housing 602. That is, the one or more lenses may be configured to move along an optical axis of the image capture device or may be configured to remain stationary during operation of the image capture device.

The housing 602 may also contain (i.e., house) a cover glass 614 that is configured to protect the one or more lenses (e.g., the lens 612) from damage caused by moisture, debris, impact, or a combination thereof. For example, as shown in FIG. 6, the cover glass 614 may be disposed in the housing 602 and positioned outward from the one or more lenses of the housing 602 (e.g., the lens 612) to protect the one or more lenses within the housing 602 from external contaminants. For example, the cover glass 614 may protect the lens 612 and/or other lenses within the housing 602 from direct impact with an object and/or debris (e.g., if the anamorphic lens module 600 is dropped).

The anamorphic lens module 600 may be configured to provide a wider field of view for the image capture device to capture images and/or videos. That is, the anamorphic lens module 600 may provide a facilitate a wider field of view of a surrounding area of the image capture device when compared to a standard (e.g., spherical lens). By way of example, the anamorphic lens module 600, via the cover glass 614 and one or more lenses of the anamorphic lens module 600 (e.g., the lens 612) may “squeeze” or otherwise compress an image or video being captured along an axis of the anamorphic lens module 600.

For example, the anamorphic lens module 600 may “squeeze” the image or video being captured along a horizontal axis that extends along a length of the anamorphic lens module 600 transverse to an optical axis of the anamorphic lens module 600. In certain configurations, the anamorphic lens module 600 may alternatively, or additionally, “squeeze” the image or video being captured along a vertical axis that extends along a width of the anamorphic lens module 600 transverse to the optical axis of the anamorphic lens module 600. Such compression (i.e., “squeezing”) may be facilitated by a size and/or shape (e.g., contour) of the cover glass 614 and/or the one or more lenses of the anamorphic lens module 600. Due to such compression along an axis (e.g., the horizontal axis), a wider field of view may be captured by the image capture device to thereby increase the surrounding area captured in the image and/or video.

To facilitate the above image capturing, the anamorphic lens module 600 may be coupled (e.g., removably coupled) to the image capture device to align the cover glass 614 and the one or more lenses of the anamorphic lens module 600 with the lens barrel along an optical axis of the lens barrel. That is, the optical axis of the anamorphic lens module 600 may be aligned with the optical axis of the lens barrel (e.g., the optical axis of the image capture device). For example, the mounting plate 608 may be coupled to the housing 602 and/or the outer casing 604 of the anamorphic lens module 600 via one or more fasteners 616, whereby the mounting plate may thus couple the anamorphic lens module 600 to the image capture device.

To further illustrate coupling of the anamorphic lens module 600 to the image capture device, FIG. 7 will now be discussed. FIG. 7 illustrates an isometric exploded view of an image capture device 704. The image capture device 704 may be similar to the image capture devices 104, 204, 206, 304, 306, 404 described above. A portion of the image capture device 704 (e.g., a body of the image capture device 704 similar to the body 102 or the body 202) has been removed from FIG. 7 for clarity and simplicity.

The image capture device 704 may include a lens barrel 718. The lens barrel 718 may be disposed in a body of the image capture device 704 and/or a body of an image capture apparatus, such as the image capture apparatuses 100, 200, 300, 400 described above. The lens barrel 718 may include one or more internal lenses disposed in the lens barrel 718, such as lens 720 illustrated in FIG. 7 as a dashed line. The one or more internal lenses of the lens barrel 718, including the lens 720, may be axially aligned an optical axis 722 of the lens barrel 718.

The image capture device 704 may include the anamorphic lens module 600, which may be removably (e.g., movably and/or releasably) coupled to the lens barrel 718. The anamorphic lens module 600 may be configured to removably couple to the lens barrel 718, either directly or indirectly, to facilitate replacement of the anamorphic lens module 600 and/or interchangeability of the anamorphic lens module 600 with one or more additional lens module. Thus, the anamorphic lens module 600 may provide further customization of the image capture device 704 to facilitate capturing images and videos in a variety of manners.

As discussed above, the anamorphic lens module 600 may include the housing 602, one or more lenses (e.g., the lens 612), and the cover glass 614, whereby the one or more lenses and the cover glass 614 may be coupled to and at least partially disposed within the housing 602. When the anamorphic lens module 600 is coupled to the lens barrel 718, the anamorphic lens module 600 may be positioned outward of the lens barrel 718 along the optical axis 722. Additionally, the cover glass 614 and the one or more lenses of the anamorphic lens module 600 (e.g., the lens 612) may be axially aligned with one another along the optical axis 722, may be axially aligned with the lens 720 of the lens barrel 718, or both. Moreover, the cover glass 614 and the one or more lenses of the anamorphic lens module 600 may be axially aligned along the optical axis of the anamorphic lens module 600.

To releasably (e.g., removably) couple the anamorphic lens module 600 to the lens barrel 718, may include, or may be coupled to, the mounting plate 608. By way of example, the anamorphic lens module 600 may include the mounting plate 608, whereby the mounting plate 608 may be coupled to the housing 602 and/or the outer casing 604 of the anamorphic lens module 600 by one or more fasteners, one or more mechanical interlocks, one or more adhesives, other connection means, or a combination thereof. For example, the fasteners 616 may extend through the mounting plate 608 (e.g., mounting holes of the mounting plate 608) and into mounting holes defined by the housing 602 of the anamorphic lens module 600.

Alternatively, the mounting plate 608 may be coupled to the housing 602 and/or the outer casing 604 free of fasteners, such as by using an adhesive. In certain configurations, the anamorphic lens module 600 may also be free of the mounting plate 608, whereby the anamorphic lens module 600 may include one or more mounting features integrated into the housing 602 and/or the outer casing 604 to releasably couple the anamorphic lens module 600 to the lens barrel 718.

To facilitate removably coupling the anamorphic lens module 600 to the lens barrel 718, the lens barrel 718 may include a bayonet 724. The bayonet 724 may be configured to be releasably coupled to the mounting plate 608 to thereby couple the anamorphic lens module 600 to the lens barrel 718. The mounting plate 608 may releasably couple to one or more fingers 726 of the bayonet 724. For example, the mounting plate 608 may include one or more lips 728 that are configured to engage the fingers 726 of the bayonet 724 to couple the anamorphic lens module 600 to the lens barrel 718. When the anamorphic lens module 600 is coupled to the lens barrel 718, the cover glass 614 and the one or more lenses of the anamorphic lens module 600 (e.g., the lens 612) may be aligned with an opening 730 of the mounting plate 608 so that the cover glass 614 and the one or more lenses of the anamorphic lens module 600 may algin with the lens 720 of the lens barrel 718. Such engagement between the lips 728 of the mounting plate 608 and the fingers 726 of the bayonet 724 may also facilitate easy connection disconnection of the anamorphic lens module 600 with respect to the lens barrel 718 to allow for replacement of the anamorphic lens module 600 and/or interchangeability of the anamorphic lens module 600 with other lens modules.

Additionally, as discussed further below, the mounting plate 608 may be configured to rotationally align the anamorphic lens module 600 with the lens barrel 718 with respect to the optical axis 722. For example, the one or more lenses of the anamorphic lens module 600 and/or the cover glass 614 may be radially asymmetrical such that rotational orientation of the anamorphic lens module 600 with respect to the lens barrel 718 about the optical axis 722 may be critical to ensure proper operation of the image capture device 704 (e.g., capturing of images or video without distortion). To help ensure proper orientation, the mounting plate 608 may include one or more hard stops 732, whereby the hard stops 732 may be configured to engage the bayonet 724 (e.g., the fingers 726 of the bayonet 724) to help align the anamorphic lens module 600 and the lens barrel 718.

The mounting plate 608 may also be configured to axially align the anamorphic lens module 600 with the lens barrel 718 (e.g., with the image capture device). For example, the mounting plate 608 may be configured align the optical axis of the anamorphic lens module 600 with the optical axis 722 of the lens barrel 718 such that the optical axis of the anamorphic lens module 600 is coaxial with the optical axis 722 of the lens barrel 718. Thus, for the configuration shown in FIG. 7, the optical axis 722 of the lens barrel 718 may also be considered the optical axis of the anamorphic lens module 600.

In addition to ensuring proper alignment between the anamorphic lens module 600 and the lens barrel 718, the mounting plate 608 may form a waterproof seal between the lens barrel 718 and the mounting plate 608. For example, as discussed above with respect to FIG. 6 and further illustrated in FIG. 7, the mounting plate 608 may further include the gasket 610. The gasket 610 may include an opening 734 that aligns with the opening 730 of the mounting plate 608 such that the bayonet 724 may extend through both the opening 734 of the gasket 610 and the opening 730 of the mounting plate 608 to engage the mounting plate 608.

The gasket 610 may be positioned between the mounting plate 608 and the lens barrel 718 to form a waterproof seal between the mounting plate 608 and the lens barrel 718. For example, the gasket 610 may be disposed along at least a portion of an exterior surface of the mounting plate 608 so that, when the bayonet 724 is coupled to the mounting plate 608, the gasket 610 may be compressed therebetween to form the waterproof seal. Thus, the mounting plate 608 and the gasket 610 may removably couple the anamorphic lens module 600 to the lens barrel 718 while still preventing moisture and/or debris from penetrating a connection therebetween.

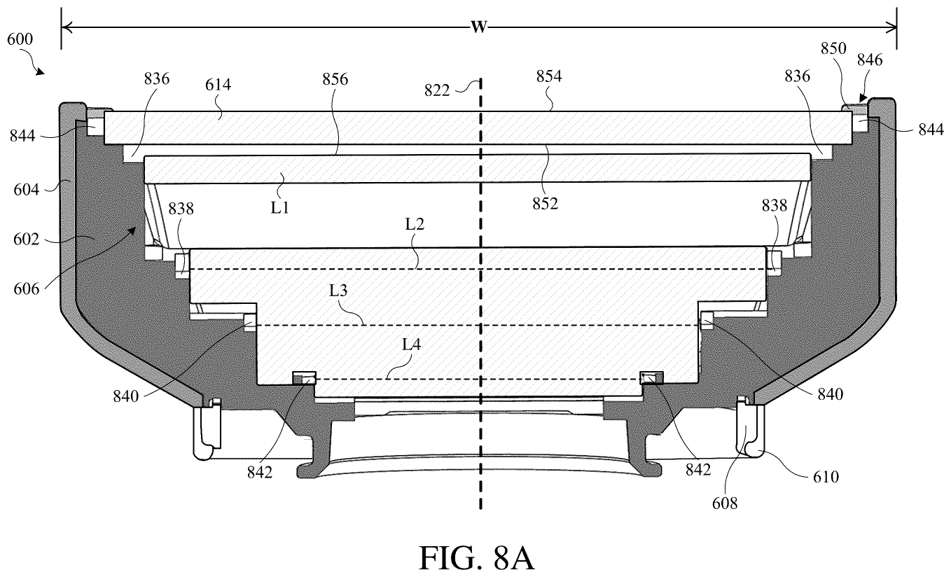

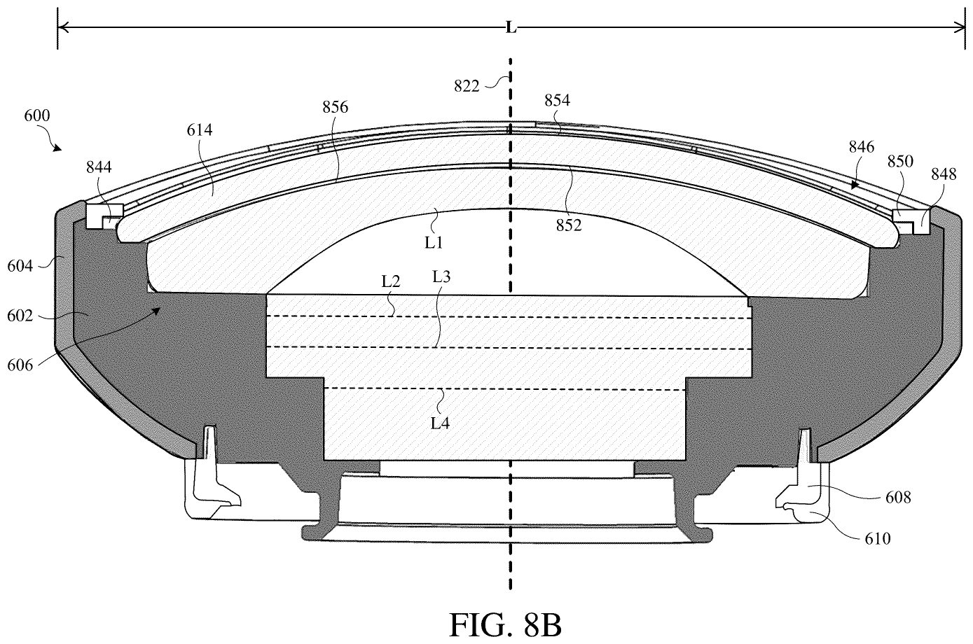

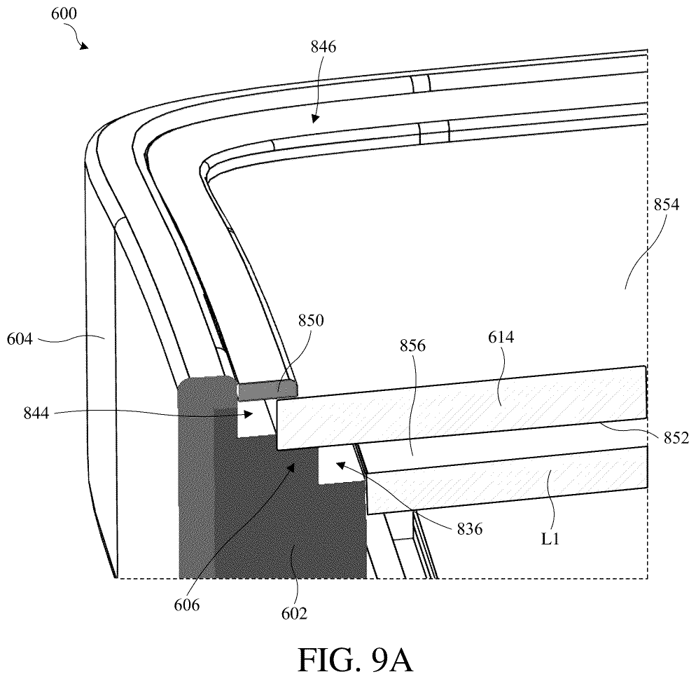

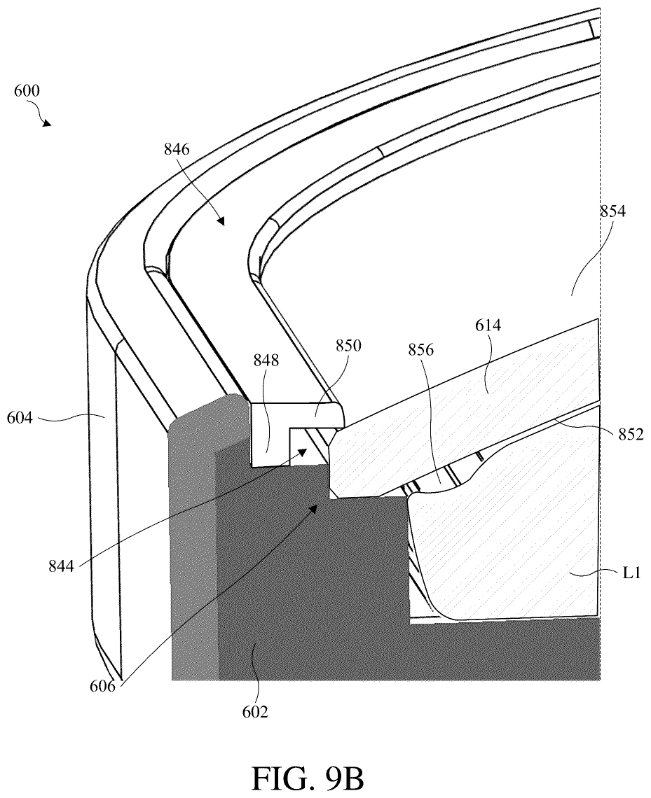

FIG. 8A illustrates cross-sectional view 8A-8A of the anamorphic lens module 600 shown in FIG. 6 taken along a width (W) of the anamorphic lens module 600. FIG. 8B illustrates cross-sectional view 8B-8B of the anamorphic lens module 600 shown in FIG. 6 taken along a length (L) of the anamorphic lens module 600. Additionally, FIGS. 9A and 9B illustrate close-up views of FIG. 8A and FIG. 8B, respectively, to better illustrate portions of the anamorphic lens module 600. FIGS. 8A-9B will now be discussed in further detail.

The width (W) of the anamorphic lens module 600 or a component thereof (e.g., the cover glass 614) may extend (e.g., may be measured) substantially perpendicular to an optical axis 822 of the anamorphic lens module 600. Similarly, the length (L) of the anamorphic lens module 600 or a component thereof (e.g., the cover glass 614) may extend (e.g. may be measured) substantially perpendicular to the optical axis 822 of the anamorphic lens module 600. The width (W) of the anamorphic lens module 600 or a component thereof (e.g., the cover glass 614) may extend transverse to the length (L) of the anamorphic lens module 600 or a component thereof (e.g., the cover glass 614). By way of example, the length (L) of the anamorphic lens module 600 may be greater than the width (W) of the anamorphic lens module 600.

As such, components thereof, such as the cover glass 614, may also have a length that is greater than their width. For example, the cover glass 614 may be radially asymmetrical with respect to the optical axis 822 such that the length of the cover glass 614 (e.g., as measured along the length (L) of the anamorphic lens module 600) may be greater than the width of the cover glass 614 (e.g., as measured along the width (W) of the anamorphic lens module 600). Therefore, as discussed above, such radial asymmetry may require proper orientation of the anamorphic lens module 600 with respect to a lens barrel, such as the lens barrel 718 shown in FIG. 7, about the optical axis 722 of the lens barrel 718 to ensure images and video are captured free of distortion.

Turning back to FIGS. 8A and 8B, the anamorphic lens module 600 may be coupled to the lens barrel 718 shown in FIG. 7. The anamorphic lens module 600 may be removably coupled to the lens barrel 718 via the mounting plate 608, whereby the mounting plate 608 may compress the gasket 610 therebetween (e.g., between the bayonet 724 of the lens barrel 718 and the mounting plate 608) to create a waterproof seal therebetween.

The anamorphic lens module 600 includes the outer casing 604 and the housing 602 disposed in the outer casing 604. The housing 602 defines the cavity 606 therein. One or more lenses may be disposed within the cavity 606 of the housing 602 and may be configured to axially align with lenses of the lens barrel 718 (e.g., the lens 720) along the optical axis 722. By way of example, the anamorphic lens module 600 may include a first lens (L1), a second lens (L2), a third lens (L3), and a fourth lens (L4) disposed in the housing 602 (e.g., in the cavity 606 of the housing 602). The lenses L2-L4 are illustrated as dashed lines for simplicity, but may be any size and/or shape. The lenses L1-L4 may be movably and/or fixedly coupling to the housing 602. For example, the lenses L1-L4 may be fixedly coupled to the housing 602 to ensure alignment of the lenses L1-L4 along the optical axis 822 of the anamorphic lens module 600. Thus, when the anamorphic lens module 600 is coupled to the image capture device (e.g., the lens barrel 718), the lenses L1-L4 be aligned with lenses of the lens barrel 718 along the optical axis 722 of the lens barrel 718.

The lenses L1-L4 may be coupled to the housing 602 in any desired manner. For example, the lenses L1-L4 may be mechanically coupled to the housing 602 via one or more fasteners, one or more mechanical interlocks, one or more engaging portions of the housing 602, or a combination thereof. The lenses L1-L4 may also or alternatively be coupled to the housing 602 by an adhesive forming a bond therebetween. By way of example, the housing 602 may define one or more lens channels for each of the lenses L1-L4, and the one or more lens channels may receive an adhesive to couple a respective one of the lenses L1-L4 to the housing 602. For example, as shown in FIGS. 8A and 9A, the housing 602 may define: a first lens channel 836 that is configured to receive the adhesive to couple the first lens L1 to the housing 602, a second lens channel 838 that is configured to receive the adhesive to couple the second lens L2 to the housing 602, a third lens channel 840 that is configured to receive the adhesive to couple the third lens L3 to the housing 602, and a fourth lens channel 842 that is configured to receive the adhesive to couple the fourth lens L4 to the housing 602.

The lens channels 836-842 may extend along all or a portion of a peripheral edge of their respective lenses L1-L4 to couple (e.g., bond) the lenses L1-L4 to the housing 602. For example, as shown in FIGS. 8A and 9A, the lens channels 836-842 may extend only along longitudinal peripheral edges of their respective lenses L1-L4 transverse to the width (W) of the anamorphic lens module 600 (e.g., into and out of the page for FIG. 8A). That is, the lens channels 836-842 may be positioned adjacent to opposing longitudinal peripheral edges of their respective lenses L1-L4 such that opposing edges of their respective lenses L1-L4 extending along the width (W) of the anamorphic lens module 600 are not located adjacent to the lens channels 836-842. For example, as shown in FIGS. 8B and 9B, the lenses L1-L4 may substantially abut the housing 602 along a width of each of the lenses L1-L4 free of the lens channels 836-842 being located therebetween.

Based on the above positioning of the lens channels 836-842, bonding of the lenses L1-L4 to the housing 602 may be done with minimal visible seams (e.g., seams creating by the adhesive). Thus, the bonding may be completed without negatively impact image or video capturing. Moreover, the bonding may be done in a manner that is not visible from a viewpoint external to the anamorphic lens module 600, thereby improving the aesthetics of the anamorphic lens module 600.

The anamorphic lens module 600 may also include the cover glass 614. As shown in FIGS. 8A-9B, the cover glass 614 may be disposed in the housing 602 and positioned outward from the lenses L1-L4 along the optical axis 822. The cover glass 614 may be aligned with the lenses L1-L4 along the optical axis 822. The cover glass 614 may also be coupled to the housing 602 in a similar manner to the lenses L1-L4. For example, the housing 602 may define a cover glass channel 844 that extends adjacent to the cover glass 614, whereby the cover glass channel 844 may be configured to receive the adhesive to couple the cover glass 614 to the housing 602. That is, the cover glass channel 844 may be similar to the lens channels 836-842 described above, whereby the cover glass channel 844 may only be positioned adjacent to longitudinal peripheral edges of the cover glass 614 to minimize visible seams and further improve the aesthetics of the anamorphic lens module 600.

It should be noted that the adhesive bonding between the lens L1-L4 and the housing 602 and/or the cover glass 614 and the housing 602 may further improve the durability of the anamorphic lens module 600. For example, the adhesive or other bonding agent utilized to couple the lenses L1-L4 and/or the cover glass 614 to the housing 602 may establish a waterproof seal therebetween. As such, the lenses L1-L4 and/or the cover glass 614 may be coupled to the housing 602 in a manner that prevents moisture and/or debris from penetrating the anamorphic lens module 600 therebetween.

The anamorphic lens module 600 may further include a trim ring 846. The trim ring 846 may be coupled to the housing 602 and may extend inward towards a central region of the anamorphic lens module 600. For example, the trim ring 846 may extend inward towards the optical axis 822 to cover the peripheral edge of the cover glass 614. The trim ring 846 may be coupled to the housing 602 and may cover both the peripheral edge of the cover glass 614 and the cover glass channel 844 from view from a viewpoint external to the anamorphic lens module 600, thereby improving the aesthetics of the anamorphic lens module 600. It should be noted that the trim ring 846 may cover an entirety or a portion of the peripheral edge of the cover glass 614. For example, the trim ring 846 may cover an entirety of the peripheral edge of the cover glass 614 along both a length and a width of the cover glass 614.

The trim ring 846 may include a base 848 and a flange 850. The base 848 may be coupled to the housing 602. For example, the base 848 may couple the trim ring 846 to the housing 602 and may be at least partially received by the cover glass channel 844. As a result, the base 848 may be bonded to the cover glass channel 844 via the adhesive or bonding agent used to couple the cover glass 614 to the housing 602. Additionally, the flange 850 may be coupled to or integrally formed with the base 848. The flange 850 may form any desired angle with the base 848 and may extend inward from the base (e.g., towards the optical axis 822) to cover the peripheral edge of the cover glass 614. Thus, the flange 850 may hide the peripheral edge of the cover glass 614 from view and may also protect the peripheral edge of the cover glass 614 from moisture, debris, impact, or a combination thereof.

As discussed above, the anamorphic lens module 600 may be configured to provide a wider field of view to the image capture device to increase the overall width of the surrounding area captured by the image capture device in an image or video. A geometry and/or positioning of the cover glass 614 may facilitate the wider field of view. Similarly, a geometry and/or positioning of the lenses L1-L4 may also facilitate the wider field of view.

By way of example and as shown in FIGS. 8B and 9B, the cover glass 614 may be disposed in the housing 602 and positioned outward from the lenses L1-L4 such that an interior surface 852 of the cover glass 614 faces the lenses L1-L4 and an exterior surface 854 of the cover glass 614 forms at least a portion of an exterior surface of the anamorphic lens module 600. That is, the exterior surface 854 of the cover glass 614 may be exposed to external elements (e.g., moisture and/or debris).

As shown in FIGS. 8B and 9B, the first lens L1 may be positioned internal to the cover glass 614 along the optical axis 922 such that the interior surface 852 of the cover glass 614 is positioned adjacent to an exterior surface 856 (e.g., outboard surface) of the first lens L1. The cover glass 614 and the first lens L1 may both be contoured in shape such that a contour of the interior surface 852 of the cover glass 614 may be complementary in shape to a contour of the exterior surface 856 of the first lens L1. Such contouring may facilitate the wider field of view for the image capture device. Thus, the contouring of any of the lenses L1-L4 and/or the cover glass 614 may be modified to adjust optical properties of the image capture device, thereby also adjusting the images and/or videos captured by the image capture device.

To further illustrate, the cover glass 614, one or more of the lenses L1-L4, or a combination thereof may by radially asymmetrical. For example, as shown in FIGS. 8A-9B, the cover glass 614 may be radially asymmetrical and one or more of the lenses L1-L4 (e.g., at least L1) may also be radially asymmetrical. The cover glass 614 may include a continuous profile extending along a width of the cover glass 614 (e.g., as shown in FIGS. 8B and 9B) and the cover glass 614 may also include a contoured profile extending along a length of the cover glass 614. That is, when a cross-section of the cover glass 614 is taken along or parallel to a width of the cover glass 614 (e.g., as shown in FIGS. 8A and 9A) the shape of the cross-section may be substantially continuous and may not exhibit substantial contouring. Conversely, a cross-section of the cover glass 614 taken along or parallel to a length of the cover glass 614 (e.g., as shown in FIGS. 8B and 9B) may exhibit substantial contouring between opposing ends of the cover glass 614. Therefore, the cover glass 614 may be configured to “compress” or otherwise distort the image or video being captured by the image capture device along one axis (e.g., along a horizontal axis or longitudinal axis), thereby capturing a wider field of view. It should also be noted that the cover glass 614 is not particularly limited to any one type of contouring or size, and thus alternative configurations may be possible.

As shown in FIGS. 8B and 9B, to further distort (e.g., “squeeze” or compress) the image or video being captured by the image capture device, both the interior surface 852 and the exterior surface 854 of the cover glass 614 may be contoured (e.g., based upon the aforementioned cross-sectional profiles of the cover glass 614), thereby increasing the field of view of the image capture device. Similarly, one or more of the lenses L1-L4 (e.g., L1 as described above) may also have contouring to further distort (e.g., “squeeze” or compress) the image or video being captured by the image capture device, thereby increasing the field of view of the image capture device. Thus, the cover glass 614, one or more of the lenses L1-L4, or a combination thereof may be configured to distort or otherwise modify the image or video being captured. As such, the anamorphic lens module 600 may be configurable by modifying the cover glass 614, one or more of the lenses L1-L4, or a combination thereof to tune a level of distortion or modification that the anamorphic lens module 600 may cause to the image or video being captured.

It should also be noted that the cover glass 614 and the lenses L1-L4 may be made of the same material or different materials. The lenses L1-L4 may be made of the same material or different materials. By way of example, the cover glass 614 may be made from glass while the lenses L1-L4 may be made from plastic. For example, the cover glass 614 may be a tempered glass and/or may be chemically strengthened (e.g., one or more additive during manufacturing and/or one or more chemical treatments to one or more surfaces of the cover glass 614, such as the exterior surface 854, the interior surface 852, or the peripheral edge of the cover glass 614). As a result, the cover glass 614 may be structurally improved to better withstand impact, moisture, debris, or a combination thereof, thereby better protecting the lenses L1-L4 disposed in the housing 602. Conversely, the lenses L1-L4 may be made of plastic to increase cost savings and/or lighten the anamorphic lens module 600. Such use of plastic for the lenses L1-L4 may not hinder structural integrity due to the improved structural integrity and protection that the cover glass 614 may provide.

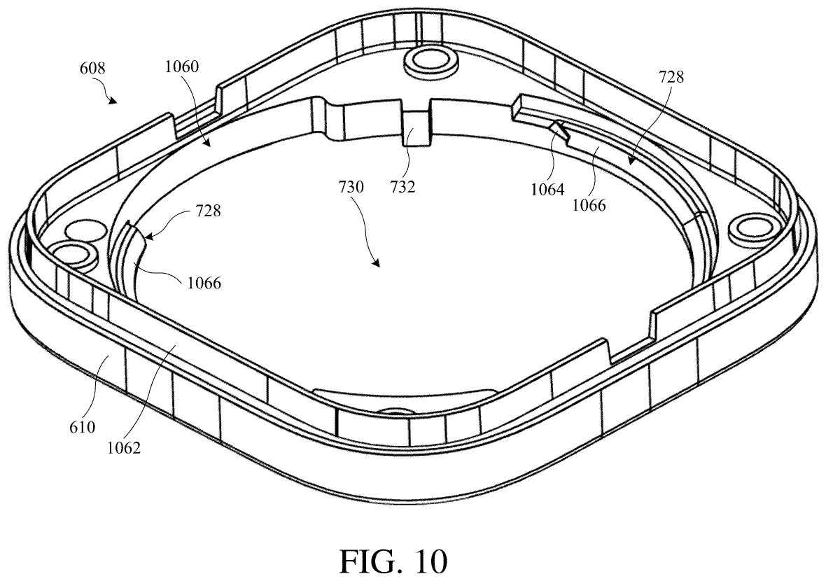

FIG. 10 illustrates an isometric view of the mounting plate 608 of the anamorphic lens module 600. As discussed above with respect to FIGS. 6 and 7, the mounting plate 608 may be configured to removably couple the anamorphic lens module 600 to the lens barrel 718. In particular, the mounting plate 608 may be configured to removable couple the anamorphic lens module 600 to the bayonet 724 of the lens barrel 718. It should also be noted that the bayonet 724 may be coupled to, integrally formed with, or separate from the lens barrel 718. That is, the bayonet 724 may be part of the image capture device and may be separate from the lens barrel 718.

The mounting plate 608 may include the lips 728, which may engage the bayonet 724 (e.g., the fingers 726 of the bayonet 724) based upon rotation of the anamorphic lens module 600 with respect to the bayonet 724 about the optical axis 722 of the lens barrel 718, or vice versa. By way of example, to couple the anamorphic lens module 600 to the lens barrel 718, the fingers 726 may be inserted into the opening 730 (e.g., inserted axially along the optical axis 722 of the lens barrel 718 into the opening 730) such that the fingers 726 may extend through the opening 730 and may be located above the lips 728. The opening 730 may also define one or more cutouts 1060, which may be complementary in shape to the fingers 726 such that, during insertion of the bayonet 724 into the opening 730, the cutouts 1060 may properly position (e.g., rotationally align) the bayonet 724 and the mounting plate 608 with respect to the optical axis 722 of the lens barrel 718.

After insertion of the bayonet 724 into the opening 730, the fingers 726 may engage the lips 728 by rotation the bayonet 724 with respect to the mounting plate 608, or vice versa. Due to such rotation, the lens barrel 718 and the anamorphic lens module 600 may be prevented from axial movement along the optical axis 722 of the lens barrel 718 with respect to each other. Additionally, the bayonet 724 may be rotated with respect to the mounting plate 608 (e.g., about the optical axis 722 of the lens barrel 718) until one or more of the fingers 726 contacts a respective one of the hard stops 732, thereby preventing further rotation of bayonet 724 with respect to the mounting plate 608 beyond the hard stops 732. That is, the hard stops 732 may prevent further rotation of the anamorphic lens module 600 about the optical axis 722 of the lens barrel 718 when the anamorphic lens module 600 is rotationally aligned with the lens barrel 718.

As discussed above, the mounting plate 608 may also include the gasket 610. The gasket 610 may be disposed along at least a portion of an exterior surface 1062 of the mounting plate 608. As such, the gasket 610 may be compressed between the mounting plate 608 and the lens barrel 718 (e.g., the bayonet 724 of the lens barrel 718), thereby creating a waterproof seal therebetween. The gasket 610 may be made of a compressible material, such as rubber, silicone, a polymer, or a combination thereof to ensure proper compression to create the waterproof seal.

Additionally, to further maintain compression of the gasket 610 between the lens barrel 718 and the mounting plate 608, the lips 728 may each include a rotation bump 1064. The rotation bump 1064 may be configured to create an angled contact between the mounting plate 608 and the lens barrel 718 to compress the gasket 610 between the mounting plate 608 and the bayonet 724. That is, the rotation bump 1064 may be located on a contact surface 1066 of the lip 728 such that, when the finger 726 contacts the contact surface 1066 and thus contacts the rotation bump 1064, a rotational position of the anamorphic lens module 600 with respect to the lens barrel 718 may be maintained. As a result, the gasket 610 may be maintained in a state of compression to maintain the waterproof seal. Moreover, positioning of the anamorphic lens module 600 may also be maintained to ensure that images and video captured by the image capture device are free of unwanted distortion.

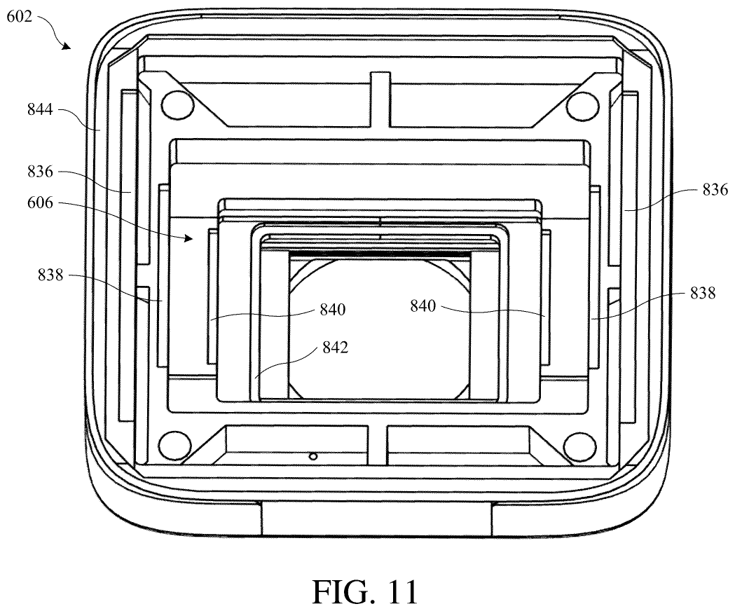

FIG. 11 illustrates an isometric view of the housing 602 of the anamorphic lens module 600. As discussed above, the housing 602 may define a cavity 606, and the lenses L1-L4 may be disposed in the cavity 606 and coupled to the housing 602. Each of the lenses L1-L4 and the cover glass 614 may be located adjacent to a respective channel within the housing 602. For example, as shown in FIGS. 8A-9B and 11, cover glass 614 may be positioned adjacent to the cover glass channel 844, the first lens L1 may be positioned adjacent to the first lens channel 836, the second lens L2 may be positioned adjacent to the second lens channel 838, the third lens L3 may be positioned adjacent to the third lens channel 840, and the fourth lens may be positioned adjacent to the fourth lens channel 842.

As shown in FIG. 11, each of the lens channels 836-842 may be disposed along opposing sides of the housing 602 (e.g., adjacent to lateral peripheral edges of the lenses L1-L4 extending along a width of the lenses L1-L4). For example, each of the lens channels 836-840 may be a pair of channels located on opposing sides of the housing 602. Conversely, the fourth lens channel 842 may extend substantially or entirely along or adjacent to the fourth lens L4. The lens channels 836-842 are not particular limited to any size, length, or shape. The lens channels 836-842 may receive an adhesive or bonding agent to bond the lenses L1-L4 to the housing 602 and maintain positioning of the lenses L1-L4 with respect to the housing 602.

The cover glass channel 844 may extend along substantially all or an entirety of a peripheral edge of the cover glass 614. As such, the cover glass channel 844 may extend along substantially all of an entirety of an interior perimeter of the housing 602. The cover glass channel 844 may be any size, length, or shape. Similar to the lens channels 836-842, the cover glass channel 844 may receive the adhesive or bonding agent to bond the cover glass 614 to the housing 602 and maintain positioning of the cover glass 614 with respect to the housing 602.

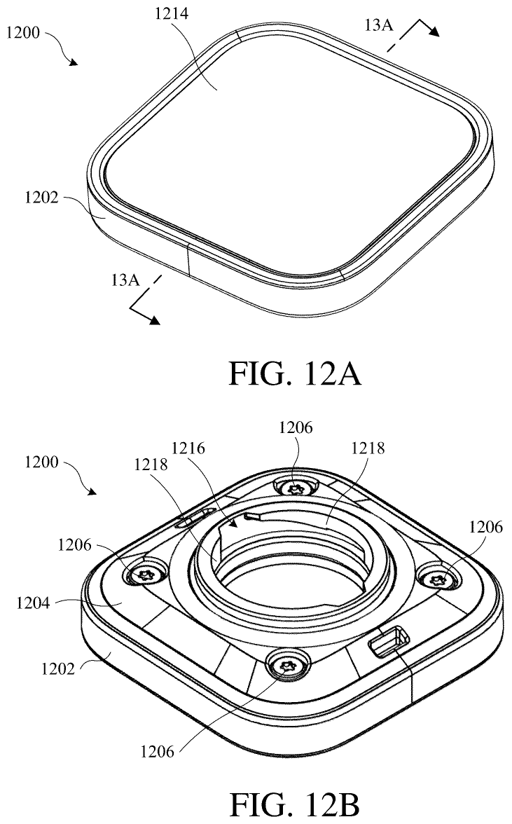

FIGS. 12A and 12B illustrate isometric views of a lens cover assembly 1200, which may be another example of a removable lens module. Similar to the anamorphic lens module 600, the lens cover assembly 1200 may be configured to be coupled (e.g., removably coupled) to a lens barrel, such as the lens barrel 718 shown in FIG. 7.

While the anamorphic lens module 600 described above is configured to modify (e.g., “squeeze” or compress) the image or video being captured by the image capture device to increase the field of view, the lens cover assembly 1200 may be free of modifications to the image or video captured. That is, the lens cover assembly 1200 may be adapted to protect the lens barrel from moisture, debris, impact, or a combination thereof to maintain the structural integrity of the lens barrel and one or more lenses (e.g., the lens 720) disposed therein without modifying the image or video captured by the image capture device.

The lens cover assembly 1200 may include a housing 1202 that defines a cavity therein. The lens cover assembly 1200 may also include a frame 1204 coupled to the housing 1202 to further define the cavity of the housing 1202. The frame 1204 may be coupled to the housing 1202 via one or more fasteners, one or more mechanical interlocks, an adhesive, other connection means, or a combination thereof. For example, the frame 1204 may be coupled to the housing 1202 by fasteners 1206 extending through the frame 1204 (through mounting holes of the frame 1204) and into the housing 1202.

A cover glass 1214, which may be similar to the cover glass 614 of the anamorphic lens module 600, may be disposed in and secured to the housing 1202. As such, when the lens cover assembly 1200 is coupled to the lens barrel (e.g., the lens barrel 718), the cover glass 1214 may protect the lens barrel 718 without hindering the field of view of the image capture device. That is, the cover glass 1214 may be disposed in the housing and positioned external to the lens barrel 718 when the lens cover assembly 1200 is coupled to the lens barrel 718.

To secure the lens cover assembly 1200 to the lens barrel 718, the frame 1204 may include a mounting portion 1216. The mounting portion 1216 may be similar to or operate similarly to the mounting plate 608 of the anamorphic lens module 600. For example, the mounting portion 1216 may include one or more lips 1218. The lips 1218 may be configured to engage fingers of a bayonet of the lens barrel. For example, the lips 1218 may engage the fingers 726 of the bayonet 724 of the lens barrel 718 to removably couple the lens cover assembly 1200 to the lens barrel 718. However, any mounting technique may be implemented. Thus, the lens cover assembly 1200 may be removably coupled to the lens barrel so that the lens cover assembly 1200 may be easily replaced and/or interchanged with one or more additional lens modules (e.g., the anamorphic lens module 600).

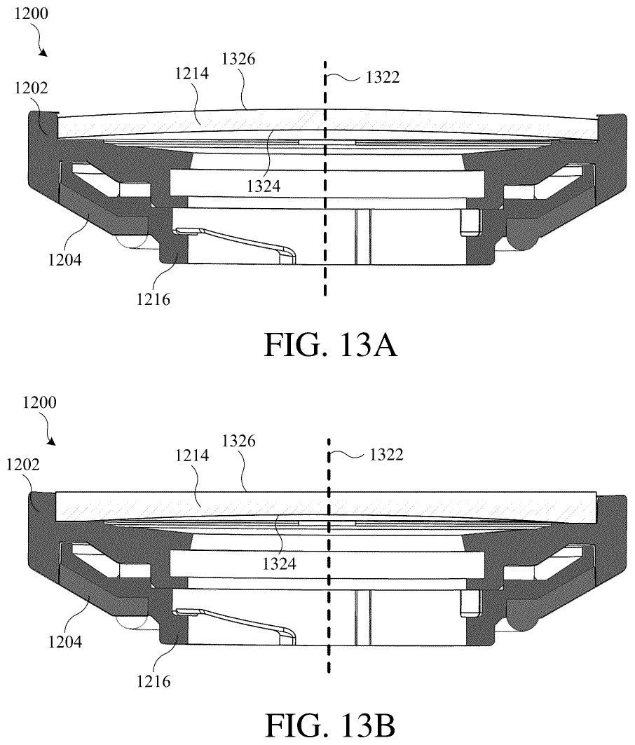

FIG. 13A illustrates cross-section 13A-13A of the lens cover assembly 1200 shown in FIG. 12A. FIG. 13B illustrates another example of a cross-section of the lens cover assembly 1200 to illustrate an alternative configuration of the cover glass 1214 of the lens cover assembly 1200.

The lens cover assembly 1200 may include the housing 1202 and the frame 1204 coupled to the housing 1202. The cover glass 1214 may be disposed in the housing 1202 and coupled to the housing 1202 to form a protective barrier for the lens barrel when the lens cover assembly 1200 is coupled to the lens barrel (e.g., the lens barrel 718). For example, the cover glass 1214 may be bonded to the housing 1202 similar to the cover glass 614 described above, thereby creating a waterproof seal between the cover glass 1214 and the housing 1202.

As described above with respect to the anamorphic lens module 600, to properly compress the image or video captured by the image capture device, the lenses L1-L4 and/or the cover glass 614 of the anamorphic lens module 600 may be radially asymmetrical such that a length of the lenses L1-L4 is greater than a width of the lenses L1-L4, respectively, and a length of the cover glass 614 is greater than a width of the cover glass 614. Due to such sizing, the overall size of the lenses L1-L4 and/or the cover glass 614 may be considerably larger than a standard spherical lens. Similarly, the lens cover assembly 1200 may be configured to coupled to a lens barrel 718 that includes one or more anamorphic lenses which may be similar in size and/or shape to one or more of the lenses L1-L4. As a result, packaging constraints may exist to accommodate the larger sizes of the aforementioned lenses.

To improve the packaging of lens cover assembly 1200 when implemented with any type of lens barrel, such as the anamorphic lens barrel as described above, the cover glass 1214 may be shaped to decrease an overall width and/or length of the cover glass 1214, as measured transverse to an optical axis 1322 of the lens cover assembly 1200. As shown in FIG. 13A, the cover glass 1214 may include an interior surface 1324 that is configured to face the lens barrel and an opposing exterior surface 1326. Both the interior surface 1324 and the exterior surface 1326 may curved (e.g., contoured) to improve the overall lateral footprint (e.g., length and/or width) of the cover glass 1214, thereby decreasing the packaging space required for the cover glass 1214. Additionally, due to the curvature of the cover glass 1214, the cover glass 1214 may allow for an even greater (e.g., wider) field of view of an image capture device when compared to a conventionally flat (e.g., planar) cover glass. Thus, the cover glass 1214 may accommodate larger aperture lenses and may not constrain the type of lens barrel coupled to the lens cover assembly 1200.

It should be noted that alternative contours or shapes of the cover glass 1214 may be possible. For example, as shown in FIG. 13B, the cover glass 1214 may still include the interior surface 1324 and the exterior surface 1326. However, in this configuration, the exterior surface 1326 may be substantially flat (e.g., substantially planar) while the interior surface 1324 may include a contour similar to that shown in FIG. 13A. Thus, the cover glass 1214 in this configuration may still improve packaging constraints and/or a field of view of the image capture device yet may also maintain a substantially flush outer surface formed by the exterior surface 1326 of the cover glass 1214 and the housing 1202.

The methods and techniques of anamorphic lens module described herein, or aspects thereof, may be implemented by an image capture apparatus, or one or more components thereof, such as the image capture apparatus 100 shown in FIGS. 1A-1B, the image capture apparatus 200 shown in FIGS. 2A-2B, the image capture apparatus 300 shown in FIG. 3, the image capture apparatus 400 shown in FIGS. 4A-4B, or the image capture apparatus 500 shown in FIG. 5. The methods and techniques of anamorphic lens module described herein, or aspects thereof, may be implemented by an image capture device, such as the image capture device 104 shown in FIGS. 1A-1B, one or more of the image capture devices 204, 206 shown in FIGS. 2A-2B, one or more of the image capture devices 304, 306 shown in FIG. 3, the image capture device 404 shown in FIGS. 4A-4B, or an image capture device of the image capture apparatus 500 shown in FIG. 5.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An image capture device, comprising:
a lens barrel disposed in a body of the image capture device; and
an anamorphic lens module configured to be coupled to the image capture device and that includes:
a housing that defines a cavity therein;
one or more lenses disposed in the cavity of the housing and aligned along an optical axis of the anamorphic lens module, wherein the optical axis of the anamorphic lens module is configured to be aligned with an optical axis of the lens barrel; and
a cover glass disposed in the housing and positioned outward from the one or more lenses along the optical axis of the anamorphic lens module such that an interior surface of the cover glass faces the one or more lenses and an exterior surface of the cover glass forms at least a portion of an exterior surface of the anamorphic lens module,
wherein the one or more lenses are plastic and the cover glass is a chemically strengthened glass.

2. The image capture device of claim 1, wherein the interior surface and the exterior surface of the cover glass are contoured to increase a field of view of the image capture device.

3. The image capture device of claim 1, wherein a length of the cover glass measured perpendicular to the optical axis of the anamorphic lens module is greater than a width of the cover glass measured perpendicular to the optical axis of the anamorphic lens module and transverse to the length of the cover glass.

4. The image capture device of claim 1, wherein the anamorphic lens module is removably coupled to the image capture device to form a waterproof seal therebetween.

5. The image capture device of claim 1, wherein the anamorphic lens module further includes a trim ring coupled to the housing and that extends inward towards the optical axis of the anamorphic lens module to cover a peripheral edge of the cover glass.

6. The image capture device of claim 5, wherein the trim ring includes:
a base coupled to the housing; and
a flange integrally formed with the base and extending inward from the base towards the optical axis of the anamorphic lens module to cover the peripheral edge of the cover glass.

7. The image capture device of claim 1, wherein the cover glass is bonded to the housing to form a waterproof seal therebetween.

8. The image capture device of claim 1, wherein the cover glass includes a continuous profile extending along a length of the cover glass and the cover glass includes a contoured profile along a width of the cover glass.

9. An anamorphic lens module for an image capture device, the anamorphic lens module comprising:
an outer casing;
a housing at least partially disposed in the outer casing and that defines a cavity therein;
one or more lenses disposed in the cavity of the housing and aligned along an optical axis of the anamorphic lens module;
a cover glass coupled to the housing and aligned with the one or more lenses along the optical axis of the anamorphic lens module, wherein the cover glass is positioned outward from the one or more lenses and is radially asymmetrical; and
a mounting plate configured to removably couple the anamorphic lens module to the image capture device, wherein the mounting plate is configured to axially align the optical axis of the anamorphic lens module with an optical axis of a lens barrel of the image capture device.

10. The anamorphic lens module of claim 9, wherein the mounting plate includes:
one or more lips configured to engage a bayonet of the lens barrel based upon rotation of the anamorphic lens module with respect to the bayonet about the optical axis of the lens barrel; and
one or more hard stops configured to prevent further rotation of the anamorphic lens module about the optical axis of the lens barrel when the anamorphic lens module is rotationally aligned with the lens barrel.

11. The anamorphic lens module of claim 10, wherein the mounting plate further includes a gasket configured to be positioned between the mounting plate and the bayonet to form a waterproof seal between the mounting plate and the lens barrel.

12. The anamorphic lens module of claim 11, wherein the gasket is disposed along at least a portion of an exterior surface of the mounting plate.

13. The anamorphic lens module of claim 12, wherein the one or more lips each include a rotation bump that is configured to create an angled contact between the mounting plate and the bayonet to compress the gasket between the mounting plate and the bayonet.

14. The anamorphic lens module of claim 9, wherein the housing defines a cover glass channel that extends adjacent to the cover glass, and the cover glass channel is configured to receive an adhesive to couple the cover glass to the housing.

15. The anamorphic lens module of claim 14, further comprising:
a trim ring coupled to the housing that covers both a peripheral edge of the cover glass and the cover glass channel from view from a viewpoint external to the anamorphic lens module.

16. The anamorphic lens module of claim 15, wherein the trim ring includes a base that couples the trim ring to the housing and is at least partially received by the cover glass channel.

17. The anamorphic lens module of claim 14, wherein the housing defines one or more lens channels for each of the one or more lenses, and the one or more lens channels are configured to receive an adhesive to couple a respective one of the one or more lenses to the housing.

18. The anamorphic lens module of claim 9, wherein the one or more lenses includes a first lens positioned internal to the cover glass along the optical axis of the anamorphic lens module such that an interior surface of the cover glass is positioned adjacent to an exterior surface of the first lens, and a contour of the interior surface of the cover glass is complementary in shape to a contour of the exterior surface of the first lens.

19. The anamorphic lens module of claim 18, wherein the first lens is radially asymmetrical.

20. An image capture device, comprising:
a lens barrel disposed in a body of the image capture device;
one or more lens disposed in the lens barrel; and
a lens cover assembly configured to be coupled to the lens barrel and that includes:
a housing;
a frame coupled to the housing and configured to couple the lens cover assembly to the lens barrel; and
a cover glass disposed in the housing and configured to be positioned external to the lens barrel,
wherein the cover glass includes an interior surface that faces the lens barrel and an opposing exterior surface, and
wherein both the interior surface and the opposing exterior surface are contoured.
